(19) United States
(12) Patent Application Publication
(10) Pub. No.: US 2016/0337805 A1
(43) Pub. Date: Nov. 17, 2016

(54) USER EQUIPMENT, DEVICE TO DEVICE USER EQUIPMENT, BASE STATION, BACKHAUL DEVICE AND ASSISTANT POSITIONING METHOD FOR DEVICE TO DEVICE USER EQUIPMENT

(71) Applicant: Institute For Information Industry, Taipei (TW)

(72) Inventors: Shu-Han LIAO, New Taipei City (TW); Yi-Hsueh TSAI, New Taipei City (TW); Yi-Ting LIN, New Taipei City (TW)

(21) Appl. No.: 15/151,639

(22) Filed: May 11, 2016

Related U.S. Application Data
(60) Provisional application No. 62/161,280, filed on May 14, 2015.

(51) Int. Cl. H04W 4/02; H04W 24/08; H04W 76/02; H04L 12/26; H04W 72/04

(52) U.S. Cl. CPC H04W 4/025; H04L 43/065; H04W 72/042; H04W 76/023; H04W 72/0413; H04W 24/08

(57) ABSTRACT

A user equipment (UE), a device to device (D2D) UE, a base station and a backhaul device and an assistant positioning method for the D2D UE are provided. The D2D UE transmits a D2D downlink reference signal in a downlink resource. The UE measures the D2D downlink reference signal to generate a downlink measurement report message and transmits the downlink measurement report message to the backhaul device. As a result, after receiving the downlink measurement report message, the backhaul device could determine location information of the user equipment based on the downlink measurement report message.

### PRIORITY

This application claims the benefit of priority based on U.S. Provisional Application Ser. No. 62/161,280 filed on May 14, 2015, which is hereby incorporated by reference in its entirety.

### FIELD

The present invention relates to a user equipment (UE), a device to device (D2D) UE, a base station, a backhaul device and an assistant positioning method for the D2D UE. More particularly, the D2D UE of the present invention transmits a D2D downlink reference signal in a downlink resource so that the UE measures the D2D downlink reference signal and generates a downlink measurement report message, and thereby the backhaul device can determine location information of the UE based on the downlink measurement report message.

### BACKGROUND

With the rapid development of the wireless communication technology in recent years, UEs (e.g., smart phones, tablet computers, or the like) have been widely used in people's daily life. To meet users' requirements, mobile communication network service providers provide various different services and applications, e.g., voice call, video call, instant message transmission or the like. Moreover, with a plurality of surrounding base stations, the user can also obtain positioning information in real time to learn the location thereof.

A prerequisite for positioning the location of the UE through the mobile communication network is that there shall be several base stations at known locations around the UE so that the backhaul device can position the location of the UE based on reference signal measurement results between the UE and these base stations. However, when the user is at a site of an emergency and the number of base stations surrounding the site is insufficient, it will be impossible to accomplish positioning by operating the UE and via the mobile communication network.

Accordingly, an urgent need exists in the art to provide an assistant positioning mechanism which allows the user to position the location of the UE via the mobile communication network even in cases where the number of surrounding base stations is insufficient.

### SUMMARY

The disclosure includes an assistant positioning mechanism for a mobile communication system. The assistant positioning mechanism uses a D2D UE having a D2D transmission function to transmit a downlink reference signal in a downlink resource so that the UE to be positioned can measure the downlink reference signal and transmit the measurement result to a backhaul device of the mobile communication system. Accordingly, with the assistant positioning mechanism, even if the number of base stations surrounding the D2D UE/conventional UE to be positioned is insufficient, the downlink reference signal transmitted in the downlink resource by a surrounding D2D UE can be measured so that the positioning can also be performed by the backhaul device based on the measurement result of measuring, by the D2D UE/conventional UE to be positioned, the downlink reference signal transmitted in the downlink resource from the surrounding D2D UE in addition to the measurement result of measuring, by the D2D UE/conventional UE to be positioned, the downlink reference signal transmitted in the downlink resource from the surrounding base station.

The disclosure includes a device to device (D2D) user equipment (UE) for a mobile communication system. The mobile communication system comprises the D2D UE, a UE, a base station and a backhaul device, and defines an uplink resource and a downlink resource. The D2D UE has a D2D signal transmission capability of using the uplink resource, and is near to the UE. The base station connects to the backhaul device. The D2D UE connects to the base station and comprises a transceiver and a processor. The processor is electrically connected to the transceiver. The processor is configured to receive a positioning reference signal transmission request message from the base station via the transceiver, generate a D2D downlink reference signal according to the positioning reference signal transmission request message, and transmit the D2D downlink reference signal in a downlink resource region of the downlink resource via the transceiver. The positioning reference signal transmission request message indicates the downlink resource region of the downlink resource. The D2D downlink reference signal is measured by the UE. The UE generates a downlink measurement report message after measuring the D2D downlink reference signal and transmits the downlink measurement report message to the backhaul device so that the backhaul device determines location information of the UE based on the downlink measurement report message.

The disclosure further includes an assistant positioning method for a device to device (D2D) user equipment (UE) of a mobile communication system. The mobile communication system comprises the D2D UE, a UE, a base station and a backhaul device, and defines an uplink resource and a downlink resource. The D2D UE has a D2D signal transmission capability of using the uplink resource, and is near to the UE. The base station connects to the backhaul device. The D2D UE connects to the base station and comprises a transceiver and a processor. The assistant positioning method is executed by the processor and comprises the following steps of: (a) receiving a positioning reference signal transmission request message from the base station via the transceiver, wherein the positioning reference signal transmission request message indicates a downlink resource region of the downlink resource; (b) generating a D2D downlink reference signal according to the positioning reference signal transmission request message; and (c) transmitting the D2D downlink reference signal in the downlink resource region via the transceiver. The D2D downlink reference signal is measured by the UE. The UE generates a downlink measurement report message after measuring the D2D downlink reference signal and transmits the downlink measurement report message to the backhaul device so that the backhaul device determines location information of the UE based on the downlink measurement report message.

The disclosure additionally includes a user equipment (UE) for a mobile communication system. The mobile communication system comprises the UE, a D2D UE, a base station, another base station and a backhaul device, and defines an uplink resource and a downlink resource. The D2D UE has a D2D signal transmission capability of using the uplink resource. The UE is near to the D2D UE. The base station connects to the backhaul device. The UE connects to the base station and comprises a transceiver and a processor. The processor is electrically connected to the transceiver. The processor is configured to measure via the transceiver a D2D downlink reference signal transmitted by the D2D UE so as to generate a downlink measurement report message, and transmit the downlink measurement report message to the backhaul device via the transceiver so that the backhaul device determines location information of the UE based on the downlink measurement report message. When the D2D UE connects to the base station, the D2D UE receives a positioning reference signal transmission request message from the base station, and when the D2D UE connects to the another base station, the D2D UE receives the positioning reference signal transmission request message from the another base station. The positioning reference signal transmission request message indicates the downlink resource region of the downlink resource. The D2D UE generates the D2D downlink reference signal according to the positioning reference signal transmission request message and transmits the D2D downlink reference signal in the downlink resource region.

The disclosure further includes a base station for a mobile communication system. The mobile communication system comprises a UE, a D2D UE, the base station and a backhaul device and defines an uplink resource and a downlink resource. The D2D UE has a D2D signal transmission capability of using the uplink resource. The D2D UE is near to the UE. The base station connects to the backhaul device. The D2D UE connects to the base station. The base station comprises a network interface, a transceiver and a processor. The processor is electrically connected to the network interface and the transceiver. The processor is configured to receive an Observed Time Difference of Arrival (OTDOA) information request message from the backhaul device via the network interface so as to generate a positioning reference signal transmission request message according to the OTDOA information request message, and transmit the positioning reference signal transmission request message to the D2D UE via the transceiver. The positioning reference signal transmission request message indicates a downlink resource region of the downlink resource so that the D2D UE generates a D2D downlink reference signal according to the positioning reference signal transmission request message and transmits the D2D downlink reference signal in the downlink resource region. After measuring the D2D downlink reference signal, the UE generates a downlink measurement report message and transmits the downlink measurement report message to the backhaul device so that the backhaul device determines location information of the UE based on the downlink measurement report message.

The disclosure additionally includes a backhaul device for a mobile communication system. The mobile communication system comprises a UE, a D2D UE, a base station, another base station and the backhaul device and defines an uplink resource and a downlink resource. The D2D UE has a D2D signal transmission capability of using the uplink resource, and is near to the UE. The base station connects to the backhaul device. The D2D UE connects to the base station. The backhaul device comprises a network unit and a processing unit. The network unit connects to the base station. The processing unit is configured to generate an Observed Time Difference of Arrival (OTDOA) information request message and transmit the OTDOA information request message to the base station via the network unit so that the base station generates a positioning reference signal transmission request message according to the OTDOA information request message and transmits the positioning reference signal transmission request message to the D2D UE. The positioning reference signal transmission request message indicates a downlink resource region of the downlink resource so that the D2D UE generates a D2D downlink reference signal according to the positioning reference signal transmission request message and transmits the D2D downlink reference signal in the downlink resource region. After measuring the D2D downlink reference signal, the UE generates a downlink measurement report message and transmits the downlink measurement report message to the backhaul device. The processing unit further receives the downlink measurement report message via the network unit and determines location information of the UE based on the downlink measurement report message.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting signal transmission between a D2D UE 1, a UE 3, a base station BS1 and a backhaul device BD in a mobile communication system MCS according to the present invention;

FIG. 2 is a schematic view depicting signal transmission between a D2D UE 1, a UE 3, a base station BS1, a base station BS2 and a backhaul device BD in a mobile communication system MCS according to the present invention;

FIG. 3 is a schematic view of the D2D UE 1 according to the present invention;

FIG. 4 is a schematic view of the UE 3 according to the present invention;

FIG. 5 is a schematic view of a base station 5 according to the present invention;

FIG. 6 is a schematic view of the backhaul device BD according to the present invention;

FIG. 7 is a flowchart diagram of an assistant positioning method according to the present invention;

FIG. 8 is a schematic view of a network architecture NA1 of an LTE mobile communication system according to the present invention;

FIG. 9A, FIG. 9B, FIG. 9C, FIG. 10A, FIG. 10B and FIG. 10C respectively depict signal transmission processes in different scenarios for positioning the UE 3;

FIG. 11 is a schematic view of a network architecture NA2 of the LTE mobile communication system according to the present invention;

FIG. 12A, FIG. 12B, FIG. 12C, FIG. 13A, FIG. 13B, FIG. 13C, FIG. 14A and FIG. 14B respectively depict signal transmission processes in different scenarios for positioning the UE 3;

FIG. 15 is a schematic view of a network architecture NA3 of the LTE mobile communication system according to the present invention;

FIG. 16A and FIG. 16B respectively depict signal transmission processes in different scenarios for positioning the UE 3;

FIG. 17 is a schematic view of a network architecture NA4 of the LTE mobile communication system according to the present invention; and

FIG. 18A, FIG. 18B, FIG. 19A and FIG. 19B respectively depict signal transmission processes in different scenarios for positioning the UE 3.

### DETAILED DESCRIPTION

In the following description, the present invention will be explained with reference to certain example embodiments thereof. The present invention relates to a user equipment (UE), a device to device (D2D) UE, a base station and a backhaul device for a mobile communication system and an assistant positioning method for the D2D UE. It shall be appreciated that, the example embodiments of the present invention are not intended to limit the present invention to any particular example, embodiment, environment, applications or implementations described in these example embodiments. Therefore, description of these example embodiments is only for purpose of illustration rather than to limit the present invention, and the scope claimed in this application shall be governed by the claims.

Additionally, in the following example embodiments and the attached drawings, elements unrelated to the present invention are omitted from depiction; and dimensional relationships among individual elements in the attached drawings are illustrated only for ease of understanding, but not to limit the actual scale.

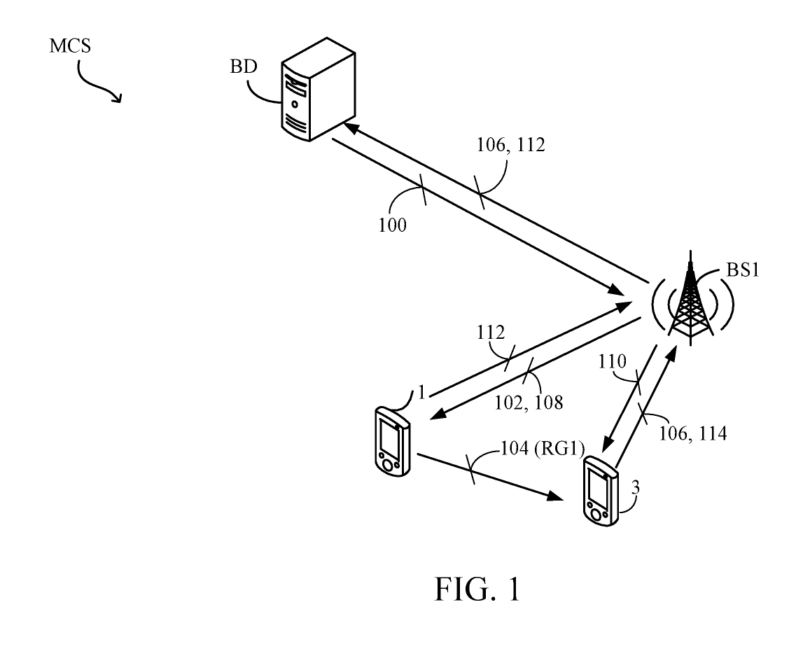

Please refer to FIG. 1 for a first embodiment of the present invention. FIG. 1 is a schematic view depicting signal transmission between a D2D UE 1, a UE 3, a base station BS1 and a backhaul device BD in a mobile communication system MCS. The mobile communication system MCS may be a mobile communication system employing an Orthogonal Frequency-Division Multiple Access (OFDMA) technology, e.g., a Long Term Evolution (LTE) mobile communication system. The mobile communication system MCS defines an uplink resource and a downlink resource.

The uplink resource is defined as a transmission resource constituted by time and frequency, and the downlink resource is also defined as a transmission resource constituted by time and frequency. Each base station in the mobile communication system MCS is configured with the uplink resource and the downlink resource of a specific frequency band. Based on the practical deployment of the base stations, base stations near to each other are usually configured with the uplink resource and the downlink resource of different frequency bands. When Time-division duplex (TDD) transmission is employed, for each base station, the uplink resource and the downlink resource are of the same frequency on the specific frequency band. Moreover, when Frequency-division duplex (FDD) transmission is employed, for each base station, the uplink resource and the downlink resource are of different frequencies on the specific frequency band. Generally, the downlink resource is used by the base station to transmit signals to the UE and the D2D UE, and the uplink resource is used by the UE and the D2D UE to transmit signals to the base station and is used for D2D signal transmission between the D2D UEs. Radio resource usage in the mobile communication system MCS of the present invention shall be readily appreciated by those of ordinary skill in the art based on the above description, and thus will not be further described herein.

In the present invention, the D2D UE 1 has the D2D signal transmission capacity of using the uplink resource, and the UE 3 may be a D2D UE or a conventional UE (i.e., not having the D2D signal transmission capacity of using the uplink resource, e.g., a UE prior to the 3GPP TS 36.305 Release 12). The D2D UE 1 is near to the UE 3. The UE 3 is the target to be positioned, and the positioning request may be sent by other devices to the backhaul device BD or sent by the UE 3 to the backhaul device BD. Additionally, different from the prior art, the D2D UE 1 of the present invention may further use the downlink resource to transmit a positioning reference signal to be measured by the UE 3, and thereby assist the backhaul device BD in positioning the UE 3.

In particular, as shown in FIG. 1, both the D2D UE 1 and the UE 3 connect to the base station BS1. When the UE 3 is to be positioned, the D2D UE 1 receives a positioning reference signal transmission request message 102 from the base station BS1. The positioning reference signal transmission request message 102 indicates a downlink resource region RG1 (e.g., but not limited to, a subframe) of the downlink resource configured for the base station BS1. After receiving the positioning reference signal transmission request message 102, the D2D UE 1 generates a D2D downlink reference signal 104 according to the positioning reference signal transmission request message 102, and transmits the D2D downlink reference signal 104 in the downlink resource region RG1 of the downlink resource. The D2D downlink reference signal 104 may be a positioning reference signal (PRS) (e.g., a positioning reference signal defined by the LTE mobile communication system) or any reference signal that is transmitted in the downlink resource and can be used for signal measurement. Moreover, the positioning reference signal transmission request message 102 not only indicates the downlink resource region RG1, but also carries associated configuration parameters that are used by the D2D UE 1 to generate the D2D downlink reference signal 104, e.g., the pattern of the positioning reference signal, the configuration of the antenna transmission port, or the like.

Thereafter, the UE 3 measures the D2D downlink reference signal 104 to generate a downlink measurement report message 106 and transmits the downlink measurement report message 106 to the backhaul device BD. In this embodiment, the UE 3 measures the D2D downlink reference signal 104 based on an observed time difference of arrival (OTDOA) and writes the measurement result into the downlink measurement report message 106. The backhaul device 4 may be any network server or a combination of several network servers in a core network. The UE 3 transmits the downlink measurement report message 106 to the backhaul device BD via the base station BS1, and in this way, the backhaul device BD can determine location information of the UE 3 according to the downlink measurement report message 106.

In practical application, in addition to the downlink measurement report message 106, the backhaul device BD may obtains more measurement information from the D2D UE and the UE which further measures the downlink reference signal transmitted by the base station, thereby determining the location information of the UE 3. For example, the base station BS1 may further transmit a downlink reference signal 108 to the D2D UE 1 or transmit a downlink reference signal 110 to the UE 3. The downlink reference signal transmitted by the base station (e.g., the downlink reference signal 108 or the downlink reference signal 110) may be a cell-specific reference signal (CRS), a positioning reference signal (PRS) or any reference signal that is transmitted in the downlink resource and can be used for signal measurement.

As the base station BS1 transmits the downlink reference signal 108, the D2D UE 1 can measure the downlink reference signal 108 to generate a D2D downlink measurement report message 112 and transmit the D2D downlink measurement report message 112 to the backhaul device BD. Moreover, as the base station BS1 transmits the downlink reference signal 110, the UE 3 can measure the downlink reference signal 110 to generate a downlink measurement report message 114 and transmit the downlink measurement report message 114 to the backhaul device BD. In this way, the backhaul device BD can determine the location information of the UE 3 further based on the D2D downlink measurement report message 112 and/or the downlink measurement report message 114 in addition to the downlink measurement report message 106.

Further speaking, the backhaul device BD usually connects to the base station BS1 in a wired way, but it is not limited thereto. The backhaul device BD generates an Observed Time Difference of Arrival (OTDOA) information request message 100, and transmits the OTDOA information request message 100 to the base station BS1. The base station BS1 generates the positioning reference signal transmission request message 102 according to the OTDOA information request message 100 and transmits the positioning reference signal transmission request message 102 to the D2D UE 1. The downlink resource region RG1 of the downlink resource indicated by the positioning reference signal transmission request message 102 may be allocated by the base station BS1 on its own or allocated based on the OTDOA information request message 100.

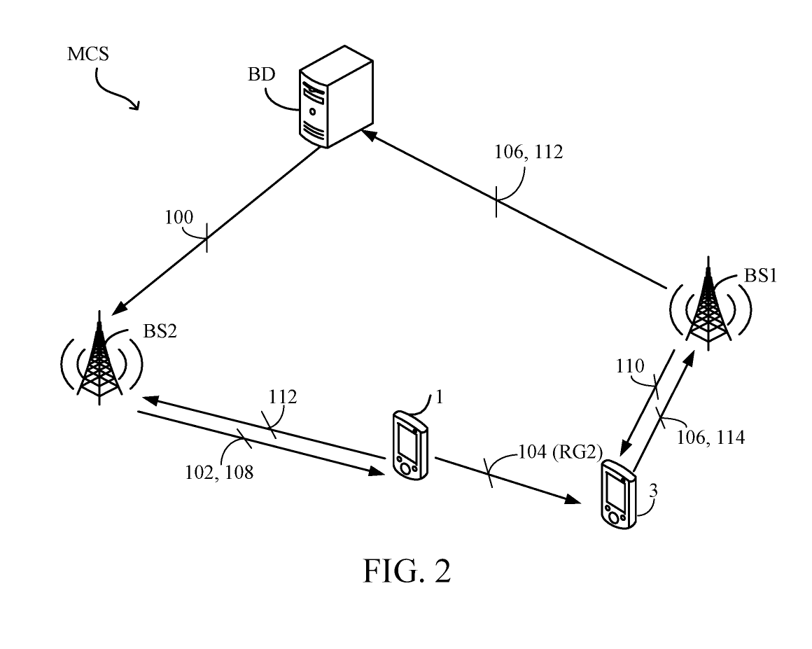

Please refer to FIG. 2 for a second embodiment of the present invention. In this embodiment, the mobile communication system MCS further comprises a base station BS2. Different from the first embodiment, the D2D UE 1 connects to the base station BS2. The base station BS2 is also configured with the uplink resource and the downlink resource of a frequency band. When the UE 3 is to be positioned, the D2D UE 1 receives the positioning reference signal transmission request message 102 from the base station BS2. The positioning reference signal transmission request message 102 indicates a downlink resource region RG2 (e.g., but not limited to, a subframe) of the downlink resource configured for the base station BS2.

When the frequency band configured for the base station BS2 is the same as the frequency band configured for the base station BS1, the UE 3 can directly measure the D2D downlink reference signal 104 in the downlink resource region RG2 to generate the downlink measurement report message 106. Similarly, after the downlink measurement report message 106 is generated, the UE 3 transmits the downlink measurement report message 106 to the backhaul device BD. In this way, the backhaul device BD can determine the location information of the UE 3 according to the downlink measurement report message 106. However, when the frequency band configured for the base station BS2 is different from the frequency band configured for the base station BS1, the UE 3 needs to additionally perform an inter-frequency Reference Signal Time Difference (RSTD) measurement procedure.

In the inter-frequency RSTD measurement procedure, the UE 3 will first inform the base station BS1 that it will temporarily switch to the inter-frequency to prevent the connection from being disconnected. Next, the UE 3 switches to the frequency band configured for the base station BS2 so as to measure the D2D downlink reference signal 104 in the downlink resource region RG2 of the downlink resource on this frequency band. After measuring the D2D downlink reference signal 104, the UE 3 switches back to the frequency band configured for the base station BS1 and informs the base station BS1 that the inter-frequency RSTD measurement has been completed. Thereafter, the UE 3 transmits the downlink measurement report message 106 that is generated by measuring the D2D downlink reference signal 104 to the backhaul device BD.

Similarly, in practical application, in addition to the downlink measurement report message 106, the backhaul device BD may obtain more measurement information from the D2D UE and the UE which further measures the downlink reference signal that is transmitted by the base station, thereby determining the location information of the UE 3. For example, the base station BS2 may transmit the downlink reference signal 108 to the D2D UE 1, or the base station BS1 may transmit the downlink reference signal 110 to the UE 3. The D2D UE 1 may measure the downlink reference signal 108 to generate the D2D downlink measurement report message 112 and transmits the D2D downlink measurement report message 112 to the backhaul device BD via the base station BS2 connected thereto. Additionally, the UE 3 may measure the downlink reference signal 110 to generate a downlink measurement report message 114 and transmit the downlink measurement report message 114 to the backhaul device BD via the base station BS1 connected thereto. In this way, the backhaul device BD can determine the location information of the UE 3 further based on the D2D downlink measurement report message 112 and/or the downlink measurement report message 114 in addition to the downlink measurement report message 106.

It shall be appreciated that, although the aforesaid embodiments are described taking one base station BS1 or two base stations BS1 and BS2 as an example, it shall be readily appreciated by those of ordinary skill in the art that there may be three or more base stations surrounding the D2D UE 1 and/or the UE 3 in the mobile communication system MCS of the present invention based on the practical depolyment of the base stations, and the D2D UE 1 and/or the UE 3 may operate in a way similar to the aforesaid measurement so as to generate other D2D downlink measurement report messages and/or downlink measurement report messages to be used by the backhaul device BD for positioning, and this will not be further described herein.

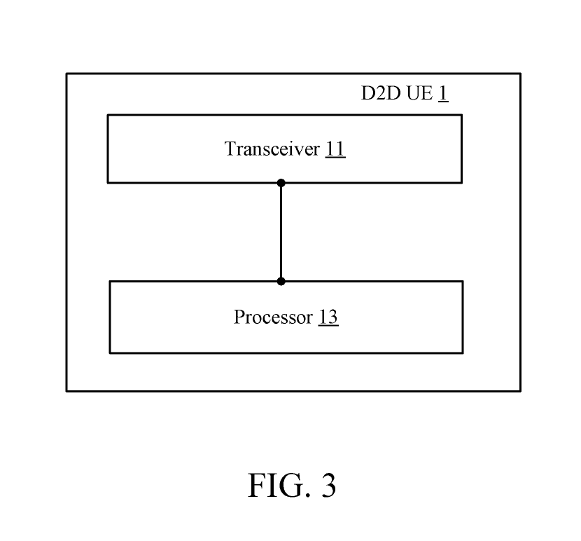

Please refer to FIG. 3 for a third embodiment of the present invention, and FIG. 3 is a schematic view of the D2D UE 1 according to the present invention. The D2D UE 1 comprises a transceiver 11 and a processor 13. The processor 13 is electrically connected to the transceiver 11. Corresponding to the first embodiment, the processor 13 receives the positioning reference signal transmission request message 102 from the base station BS1 via the transceiver 11; and Corresponding to the second embodiment, the processor 13 receives the positioning reference signal transmission request message 102 from the base station BS2 via the transceiver 11. After receiving the positioning reference signal transmission request message 102, the processor 13 generates the D2D downlink reference signal 104 according to the positioning reference signal transmission request message 102. Thereafter, the processor 13 transmits, via the transceiver 11, the D2D downlink reference signal 104 in the downlink resource region (e.g., the downlink resource region RG1 or the downlink resource region RG2) of the downlink resource that is configured for the base station which D2D UE 1 connects to.

Moreover, corresponding to the first embodiment, the processor 13 may further measure the downlink reference signal 108 transmitted by the base station BS1 via the transceiver 11 so as to generate the D2D downlink measurement report message 112, and transmit the D2D downlink measurement report message 112 to the backhaul device BD via the transceiver 11. Additionally, corresponding to the second embodiment, the processor 13 may further measure the downlink reference signal 108 transmitted by the base station BS2 via the transceiver 11 so as to generate the D2D downlink measurement report message 112, and transmit the D2D downlink measurement report message 112 to the backhaul device BD via the transceiver 11. As described above, when the frequency band configured for the base station BS1 is different from the frequency band configured for the base station BS2, the processor 13, via the transceiver 11, processes the D2D downlink reference signal 104 to be carried in the downlink resource region RG2 of the downlink resource on the frequency band configured for the base station BS2 so that the D2D downlink reference signal 104 is measured by the UE 1 through the inter-frequency RSTD measurement procedure.

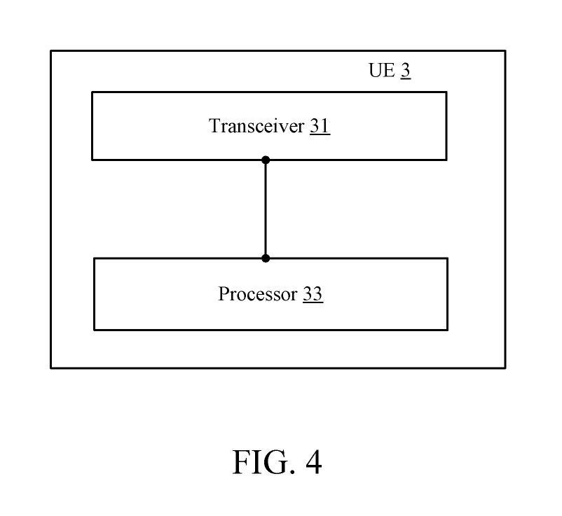

Please refer to FIG. 4 for a fourth embodiment of the present invention, and FIG. 4 is a schematic view of the UE 3 according to the present invention. The UE 3 comprises a transceiver 31 and a processor 33. The processor 33 is electrically connected to the transceiver 31. The processor 33 measures the D2D downlink reference signal 104 transmitted by the D2D UE 1 via the transceiver 31 so as to generate the downlink measurement report message 106. Thereafter, the processor 33 transmits the downlink measurement report message 106 to the backhaul device BD via the transceiver 31. In this way, the backhaul device BD can determine the location information of the UE 3 based on the downlink measurement report message 106.

Corresponding to the first embodiment, when the D2D UE 1 and the UE 3 connect to the same base station BS1, the D2D UE 1 transmits the D2D downlink reference signal 104 in the downlink resource region RG1 of the downlink resource configured for the base station BS1, and the processor 33 measures the D2D downlink reference signal 104 in the downlink resource region RG1 via the transceiver 31. As described earlier, the base station BS1 may transmit the downlink reference signal 110 to the UE 3, so the processor 33 may further measure the downlink reference signal 110 via the transceiver 31 to generate the downlink measurement report message 114. Thereafter, the processor 33 transmits the downlink measurement report message 114 to the backhaul device BD via the transceiver 31. In this way, the backhaul device BD can determine the location information of the UE 3 according to the downlink measurement report message 106 and the downlink measurement report message 114.

On the other hand, corresponding to the second embodiment, when the D2D UE 1 and the UE 3 connect to different base stations (i.e., the D2D UE 1 connects to the base station BS2, and the UE 3 connects to the base station BS1), the D2D UE 1 transmits the D2D downlink reference signal 104 in the downlink resource region RG2 of the downlink resource configured for the base station BS2 based on the positioning reference signal transmission request message 102 received from the base station BS2, and the processor 33 performs the inter-frequency RSTD measurement procedure to measure the D2D downlink reference signal 104 in the downlink resource region RG2 via the transceiver 31. Similarly, the processor 33 may also measure the downlink reference signal 110 transmitted by the base station BS1 via the transceiver 31 so as to generate and transmit the downlink measurement report message 114 to the backhaul device BD.

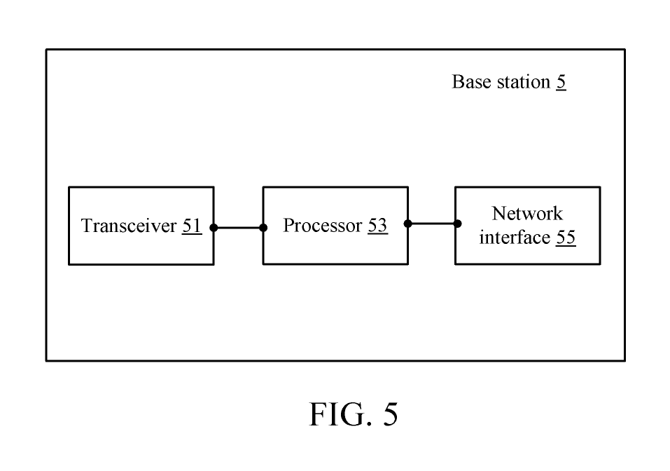

Please refer to FIG. 5 for a fifth embodiment of the present invention, and FIG. 5 is a schematic view of the base station 5 according to the present invention. The base station 5 may be the base station BS1 or the base station BS2. The base station 5 comprises a transceiver 51, a processor 53 and a network interface 55. The processor 53 is electrically connected to the transceiver 51 and the network interface 55. The network interface 55 connects to the backhaul network BD in a wired way. The processor 53 receives an Observed Time Difference of Arrival (OTDOA) information request message 100 from the backhaul device BD via the network interface 55 to generate the positioning reference signal transmission request message 102 according to the OTDOA information request message 100.

Thereafter, the processor 53 transmits the positioning reference signal transmission request message 102 to the D2D UE 1 via the transceiver 51. In this way, the D2D UE 1 can generate the D2D downlink reference signal 104 according to the positioning reference signal transmission request message 102. Moreover, the processor 53 may further receive the downlink measurement report message 106 from the D2D UE 1 via the transceiver 51, and transmit the downlink measurement report message 106 to the backhaul device BD via the network interface 55 so that the backhaul device BD determines the location information of the UE 3 according to the downlink measurement report message 106.

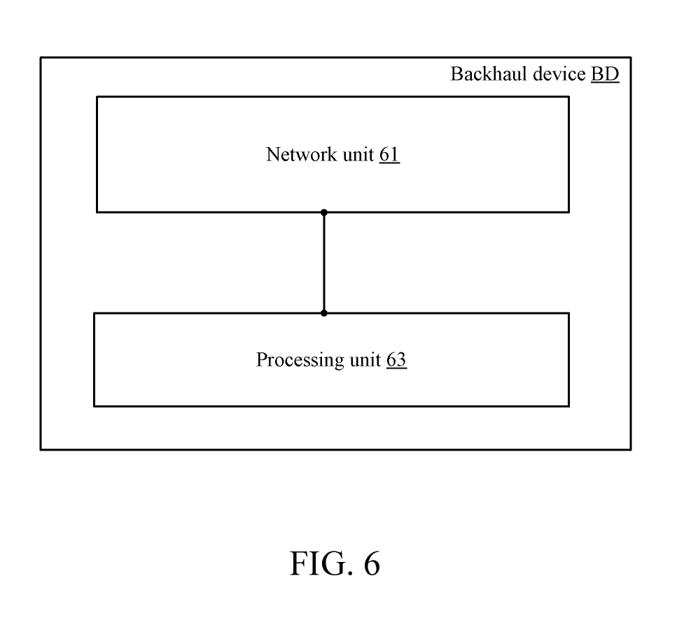

Please refer to FIG. 6 for a sixth embodiment of the present invention, and FIG. 6 is a schematic view of the backhaul device BD according to the present invention. The backhaul device BD comprises a network unit 61 and a processing unit 63. As described earlier, the backhaul device BD may be any network server or a combination of several network servers in a core network. When the backhaul device BD is a single network server, the network unit 61 is a network interface, and the processing unit 63 is a processor. Moreover, when the backhaul device BD is a combination of several network servers, the network unit 61 is a set of network interfaces of the network servers, and the processing unit 63 is a set of processors of the network servers.

The network unit 61 connects to the base stations (e.g., the base station BS1 and the base station BS2) in the mobile communication system MCS in a wired way. The processing unit 63 generates an Observed Time Difference of Arrival (OTDOA) information request message 100. Corresponding to the first embodiment, when the D2D UE 1 connects to the base station BS1, the processing unit 63 transmits the OTDOA information request message 100 to the base station BS1 via the network unit 61, and receives the downlink measurement report message 106 from the D2D UE 1 through the base station BS1 and via the network unit 61. Additionally, corresponding to the second embodiment, when the D2D UE 1 connects to the base station BS2, the processing unit 63 transmits the OTDOA information request message 100 to the base station BS2 via the network unit 61, and receives the downlink measurement report message 106 from the D2D UE 1 through the base station BS2 and via the network unit 61.

Thereafter, the processing unit 63 determines the location information of the UE 3 according to the downlink measurement report message 106. Moreover, the processing unit 63 may also receive the D2D downlink measurement report message 112 from the D2D UE 1 and/or receive the downlink measurement report message 114 from the UE 3 via the network unit 61. In this way, the processing unit 63 can determine the location information of the UE 3 further based on the D2D downlink measurement report message 112 and/or the downlink measurement report message 114 in addition to the downlink measurement report message 106.

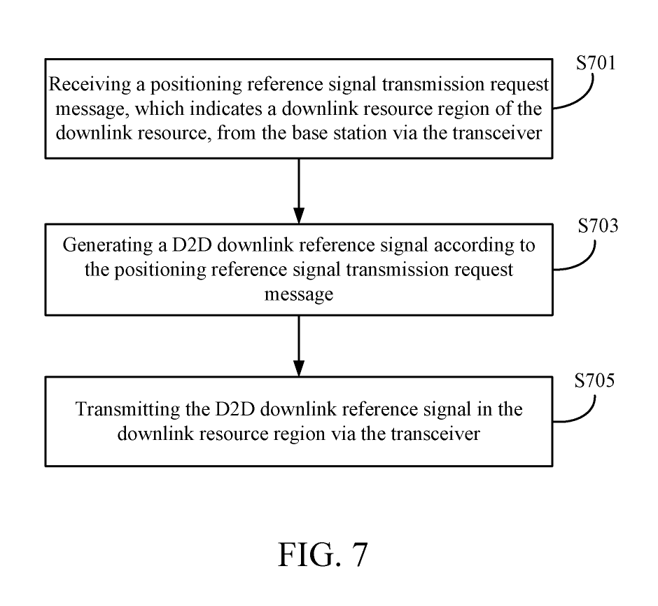

Please refer to FIG. 7 for a seventh embodiment of the present invention, and FIG. 7 is a flowchart diagram of an assistant positioning method according to the present invention. The assistant positioning method according to the present invention is adapted for use in a D2D UE of a mobile communication system (e.g., the D2D UE 1 in the aforesaid mobile communication system MCS). The mobile communication system comprises a D2D UE, a UE, a base station and a backhaul device. The mobile communication system defines an uplink resource and a downlink resource. The D2D UE has a D2D signal transmission capability of using the uplink resource. The D2D UE is near to the UE. The base station connects to the backhaul device. The D2D UE connects to the base station and comprises a transceiver and a processor. The assistant positioning method is executed by the processor.

First, in step S701, a positioning reference signal transmission request message is received from the base station via the transceiver. The positioning reference signal transmission request message indicates a downlink resource region of the downlink resource. Then, in step S703, a D2D downlink reference signal is generated according to the positioning reference signal transmission request message. Next, in step S705, the D2D downlink reference signal is transmitted in the downlink resource region via the transceiver.

As described earlier, the D2D downlink reference signal is measured by the UE (e.g., the UE 3). In this way, the UE generates a downlink measurement report message after measuring the D2D downlink reference signal and transmits the downlink measurement report message to the backhaul device so that the backhaul device determines location information of the UE based on the downlink measurement report message.

Additionally, when the base station further transmits a downlink reference signal in an embodiment, the assistant positioning method of the present invention may further comprise the following steps of: measuring the downlink reference signal via the transceiver to generate a D2D downlink measurement report message; and transmitting the D2D downlink measurement report message to the backhaul device via the transceiver. In this way, the backhaul device can determine the location information of the UE based on the downlink measurement report message and the D2D downlink measurement report message.

Moreover, in an embodiment, the mobile communication system further comprises another base station, and the UE connects to the another base station. When the base station further transmits a downlink reference signal to the D2D UE, the assistant positioning method of the present invention further comprises the following steps of: measuring the downlink reference signal via the transceiver to generate a D2D downlink measurement report message; and transmitting the D2D downlink measurement report message to the backhaul device via the transceiver.

Furthermore, when the another base station further transmits another downlink reference signal to the UE, the UE further measures the another downlink reference signal to generate another downlink measurement report message and transmits the another downlink measurement report message to the backhaul device. In this way, the backhaul device can determine the location information of the UE based on the downlink measurement report message, the another downlink measurement report message and the D2D downlink measurement report message. However, when the base station is configured with the uplink resource and the downlink resource of a frequency band, the another base station is configured with the uplink resource and the downlink resource of another frequency band different from the frequency band, the step 705 further comprises the following step of: processing the D2D downlink reference signal to be carried in the downlink resource region of the downlink resource on the frequency band via the transceiver.

In addition to the aforesaid steps, the assistant positioning method of the present invention can also execute all the operations and have all the corresponding functions set forth in all the aforesaid embodiments. How this embodiment executes these operations and has these functions will be readily appreciated by those of ordinary skill in the art based on the explanation of all the aforesaid embodiments, and thus will not be further described herein.

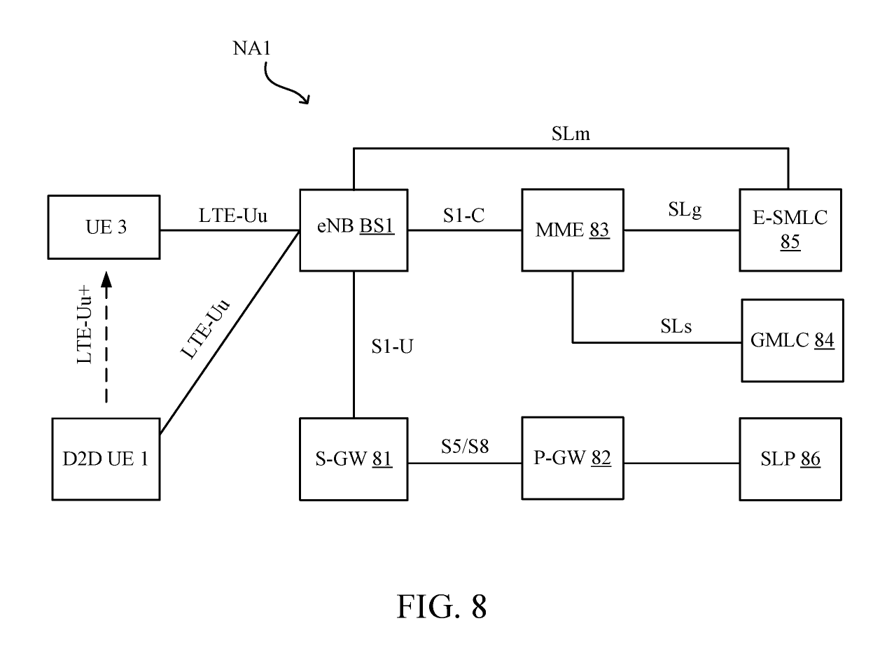

An eighth embodiment of the present invention is as shown in FIG. 8, which is a schematic view of a network architecture NA1 of the LTE mobile communication system, and the network architecture NA1 is adapted for use in the aforesaid first embodiment. Specifically, the network architecture NA1 comprises a D2D UE 1, a UE 3, an eNB BS1, a Serving Gateway (S-GW) 81, a Packet Data Network Gateway (P-GW) 82, a Mobility Management Entity (MME) 83, a Gateway Mobile Location Centre (GMLC) 84, an Evolved Serving Mobile Location Center (E-SMLC) 85, a Hosted Secure User Plane Location (SUPL) Location Platform (SLP) 86. The eNB BS1 may have a Location Measurement Unit (LMU) used to generate the downlink reference signal, e.g., the cell-specific reference signal (CRS) and the positioning reference signal (PRS).

Under the network architecture NA1 of this embodiment, the D2D UE 1 and the UE 3 connect to the same eNB BS1. The D2D UE 1 and the UE 3 respectively communicate with the eNB BS1 via an LTE-Uu interface. The D2D UE 1 transmits the D2D downlink reference signal 104 to the UE 3 via an LTE-Uu+ interface of the present invention. Further speaking, the LTE-Uu+ interface is a downlink resource region allocated by the eNB BS1 or the backhaul device BD so that the D2D UE processes the D2D downlink reference signal 104 to be carried in the downlink resource region.

Additionally, the eNB BS1 communicates with the MME 83 via an S1-C interface. The MME 83 communicates with the GMLC 84 via an SLs interface. The MME 83 communicates with the E-SMLC 85 via an SLg interface. The eNB BS1 communicates with the E-SMLC 85 via an SLm interface. The eNB BS1 communicates with the S-GW 81 via an S1-U interface. The S-GW 81 communicates with the P-GW 82 via an S5/S8 interface. The P-GW 82 communicates with the SLP 86 via a custom interface (e.g., an SGi interface or an Lup interface). The aforesaid transmission interfaces have been defined within the technical specification of the LTE mobile communication system (e.g., the 3GPP TS 36.305 V12.2.0), and thus will not be further described herein.

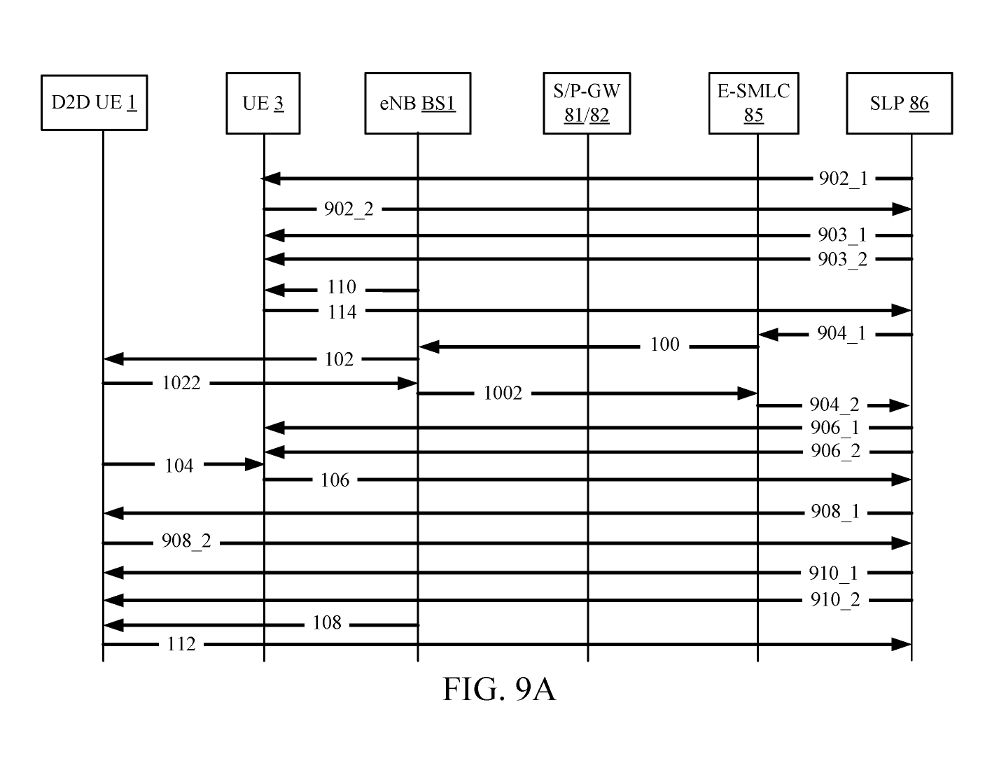

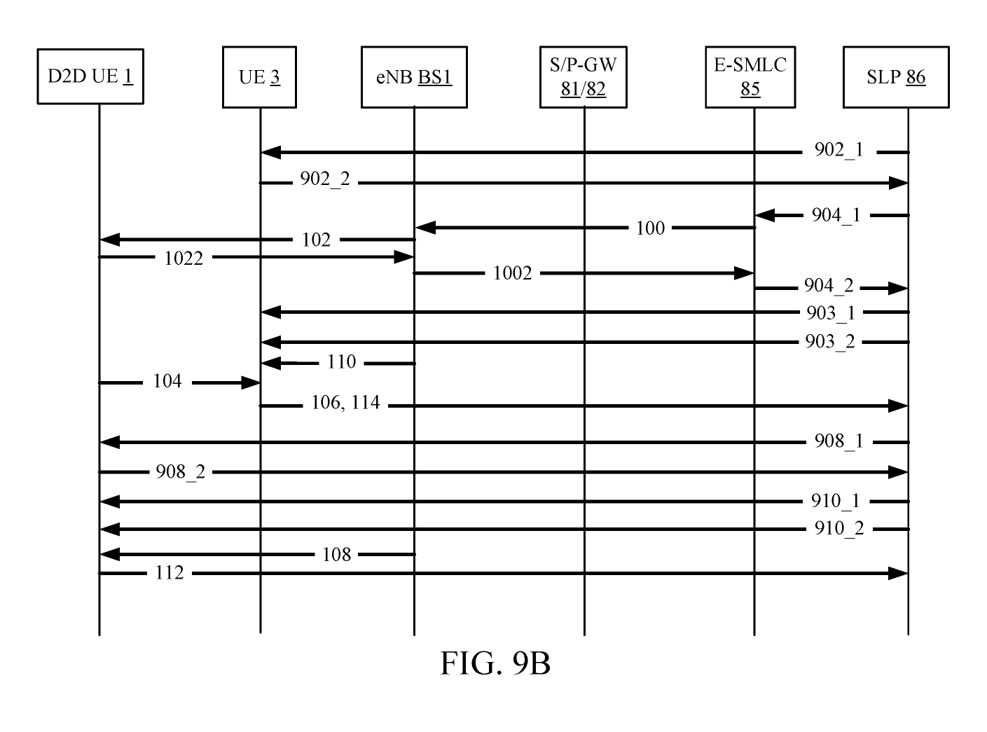

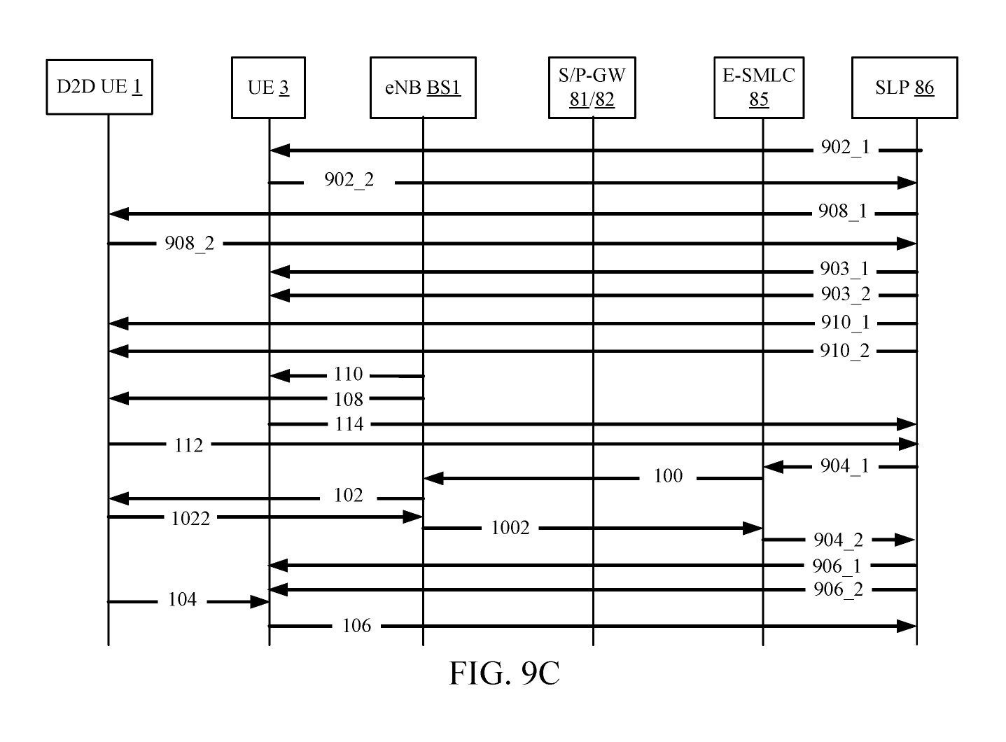

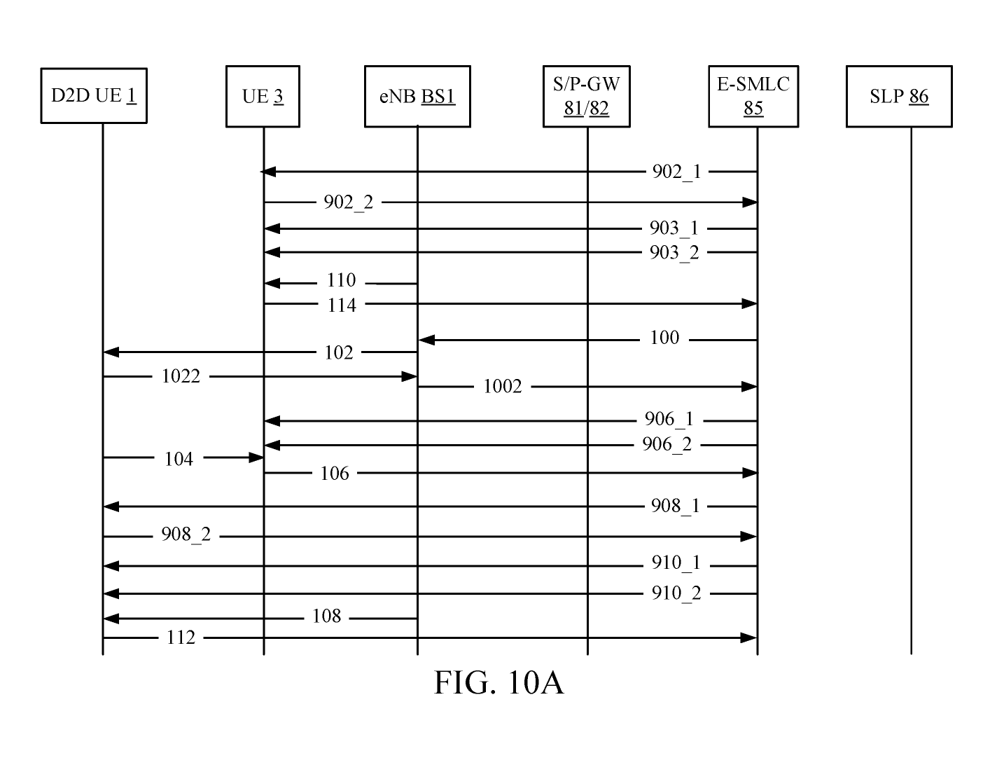

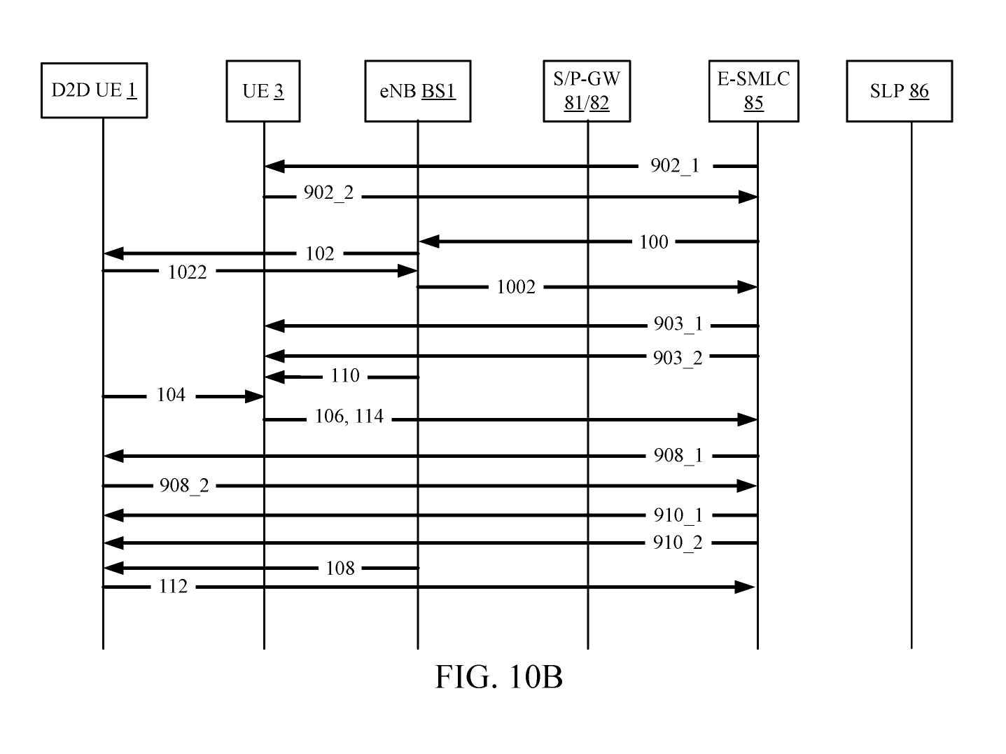

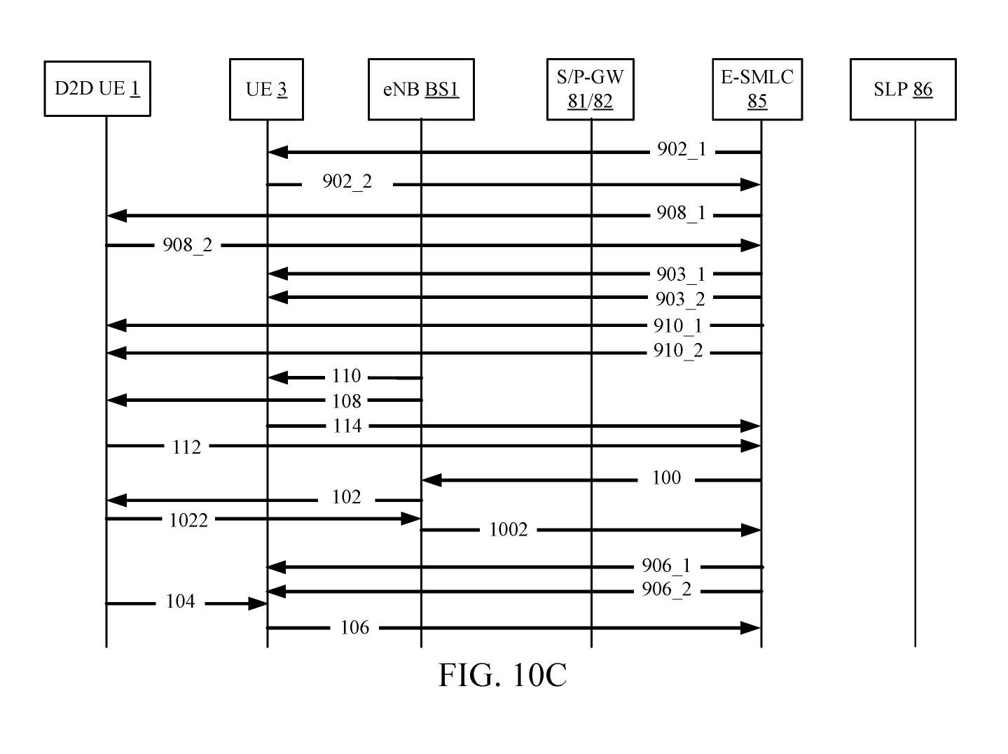

FIG. 9A, FIG. 9B, FIG. 9C, FIG. 10A, FIG. 10B and FIG. 10C respectively depict signal transmission processes in different scenarios for positioning the UE 3. It shall be appreciated that, most of the signal transmission of FIG. 9A, FIG. 9B, FIG. 9C, FIG. 10A, FIG. 10B and FIG. 10C represents the signal transmission in a control plane rather than physical transmission paths of signals. First, in the scenario depicted in FIG. 9A, the SLP 86 transmits an LTE positioning protocol request capabilities (LPP request capabilities) message 902_1 to the UE 3, and the UE 3 transmits an LPP provide capabilities message 902_2 back to the SLP 86.

Thereafter, the SLP 86 transmits an LPP assistance data message 903_1 and an LPP request location information message 903_2 to the UE 3. Next, the UE 3 measures the downlink reference signal 110 transmitted by the eNB BS1. After measuring the downlink reference signal 110, the UE 3 transmits the downlink measurement report message 114 to the SLP 86.

Thereafter, the SLP 86 transmits an OTDOA information request message 904_1 to the E-SMLC 85. The E-SMLC 85 transmits the OTDOA information request message 100 to the eNB BS1. The eNB BS1 transmits the positioning reference signal (PRS) transmission request message 102 to the D2D UE 1. The D2D UE 1 transmits a PRS transmitting confirm message 1022 to the eNB BS1. The eNB BS1 thus transmits an OTDOA information response message 1002 to the E-SMLC 85. The E-SMLC 85 transmits an OTDOA information response message 904_2 to the SLP 86. In the present invention, the OTDOA information response message 1002 carries information associated with that the eNB BS1 requests the D2D UE 1 to transmit the D2D downlink reference signal 104 (e.g., but not limited to, the downlink resource region RG1, the ID of the D2D UE 1 or the like).

Next, the SLP 86 transmits an LPP assistance data message 906_1 and an LPP request location information message 906_2 to the UE 3. Then, the UE 3 measures the D2D downlink reference signal 104 transmitted by the D2D UE 1, and transmits the downlink measurement report message 106 to the SLP 86 after measuring the D2D downlink reference signal 104.

Thereafter, the SLP 86 transmits an LPP request capabilities message 908_1 to the D2D UE 1, and the D2D UE 1 transmits an LPP provide capabilities message 908_2 back to the SLP 86. The SLP 86 transmits an LPP assistance data message 910_1 and an LPP request location information message 910_2 to the D2D UE 1. Next, the D2D UE 1 measures the downlink reference signal 108 transmitted by the eNB BS1. After measuring the downlink reference signal 108, the D2D UE 3 transmits the D2D downlink measurement report message 112 to the SLP 86. In this way, the SLP 86 can determine the location information of the UE 3 at least based on the downlink measurement report message 106, the D2D downlink measurement report message 112 and the downlink measurement report message 114.

As compared to the scenario depicted in FIG. 9A, in the scenario depicted in FIG. 9B, the UE 3 first measures the downlink reference signal 110 transmitted by the eNB BS1 and the D2D downlink reference signal 104 transmitted by the D2D UE 1, and then transmits the downlink measurement report message 106 and the downlink measurement report message 114 together to the SLP 86. Moreover, in this scenario, the SLP 86 only needs to transmit the LPP assistance data message 903_1 and the LPP request location information message 903_2 to the UE 3 and does not need to transmit the LPP assistance data message 906_1 and the LPP request location information message 906_2 to the UE 3.

As compared to the scenario depicted in FIG. 9A, in the scenario depicted in FIG. 9C, the D2D UE 1 first measures the downlink reference signal 108 transmitted by the eNB BS1 and then the UE 3 measures the D2D downlink reference signal 104 transmitted by the D2D UE 1. The overall operation can be readily appreciated by those of ordinary skill in the art based on FIG. 9B and FIG. 9C, and thus will not be further described herein.

As compared to the scenario depicted in FIG. 9A, in the scenario depicted in FIG. 10A, the LPP request capabilities message 902_1 is generated by the E-SMLC 85 and then transmitted to the UE 3, and the LPP provide capabilities message 902_2 is transmitted back to the E-SMLC 85 from the UE 3. Moreover, the LPP request capabilities message 908_1 is generated by the E-SMLC 85 and then transmitted to the D2D UE 1, and the LPP provide capabilities message 908_2 is transmitted back to the E-SMLC 85 from the D2D UE 1.

Additionally, the LPP assistance data message 903_1 and the LPP request location information message 903_2 are also generated by the E-SMLC 85 and then transmitted to the UE 3, and the LPP assistance data message 906_1 and the LPP request location information message 906_2 are also generated by the E-SMLC 85 and transmitted to the UE 3. Similarly, the LPP assistance data message 910_1 and the LPP request location information message 910_2 are also generated by the E-SMLC 85 and then transmitted to the D2D UE 1.

Furthermore, the downlink measurement report message 106, the D2D downlink measurement report message 112 and the downlink measurement report message 114 are transmitted back to the E-SMLC 85 so as to be used by the E-SMLC 85 for determining the location information of the UE 3. Moreover, the SLP 86 does not need to transmit the OTDOA information request message 904_1 to the E-SMLC 85 or receive the OTDOA information response message 904_2 from the E-SMLC 85. In other words, different from the scenario depicted in FIG. 9A, the positioning service in the scenario depicted in FIG. 10A is achieved by the E-SMLC 85 rather than the SLP 86.

As compared to the scenario depicted in FIG. 10A, in the scenario depicted in FIG. 10B, the UE 3 first measures the downlink reference signal 110 transmitted by the eNB BS1 and the D2D downlink reference signal 104 transmitted by the D2D UE 1, and then transmits the downlink measurement report message 106 and the downlink measurement report message 114 together to the E-SMLC 85. Moreover, in this scenario, the E-SMLC 85 only needs to transmit the LPP assistance data message 903_1 and the LPP request location information message 903_2 to the UE 3 and does not need to transmit the LPP assistance data message 906_1 and the LPP request location information message 906_2 to the UE 3.

As compared to the scenario depicted in FIG. 10A, in the scenario depicted in FIG. 10C, the D2D UE 1 first measures the downlink reference signal 108 transmitted by the eNB BS1 and then the UE 3 measures the D2D downlink reference signal 104 transmitted by the D2D UE 1. The overall operation can be readily appreciated by those of ordinary skill in the art based on FIG. 10A, FIG. 10B and FIG. 10C, and thus will not be further described herein.

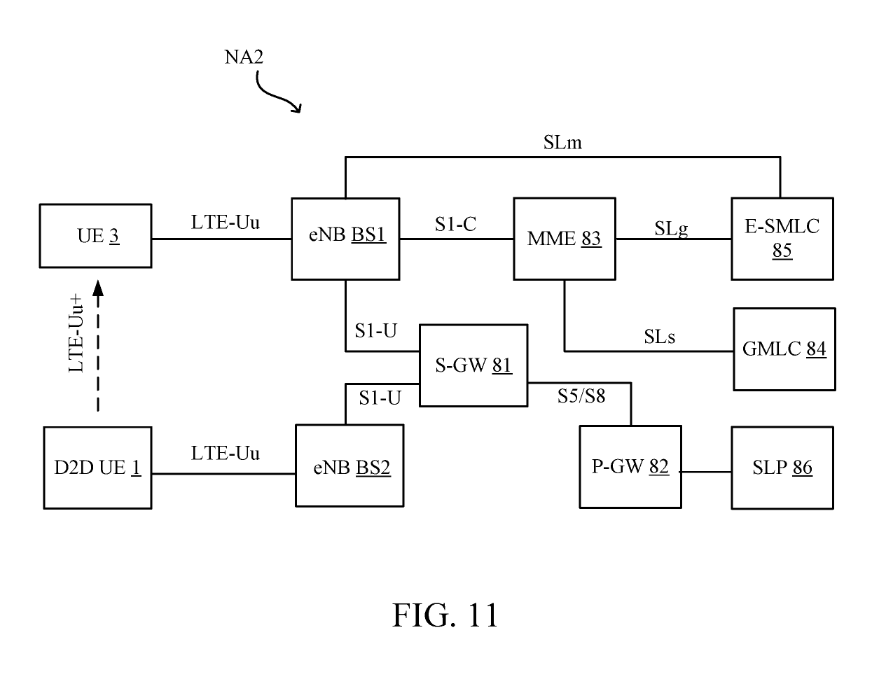

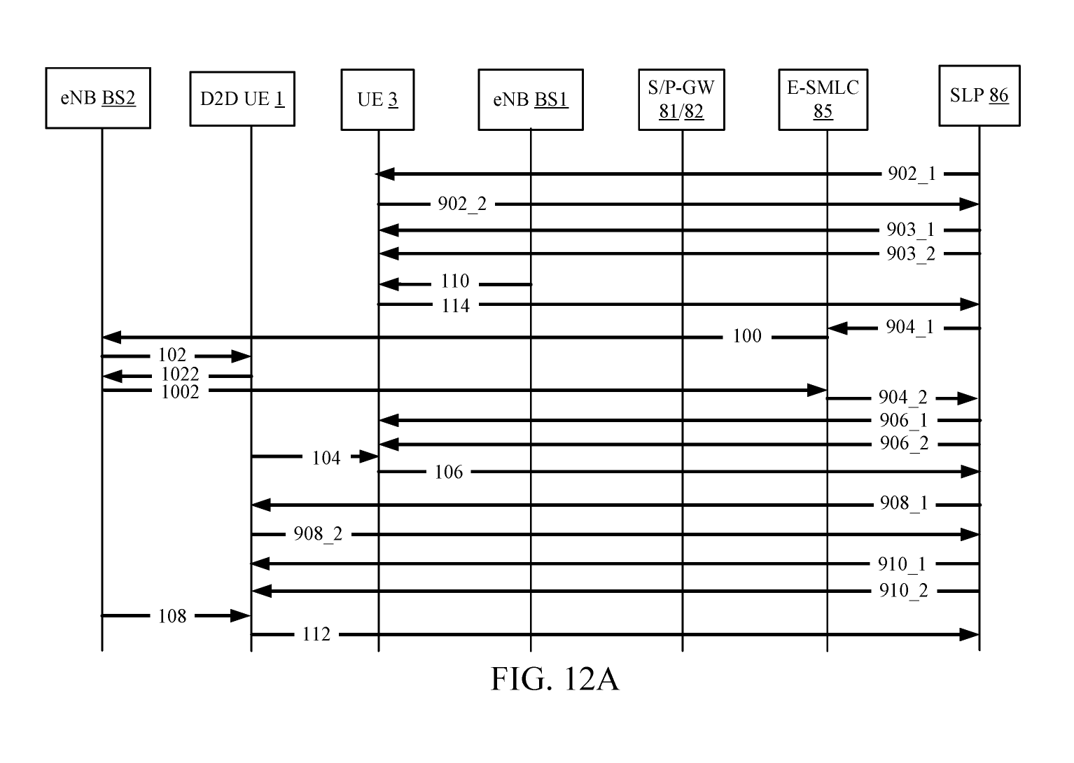

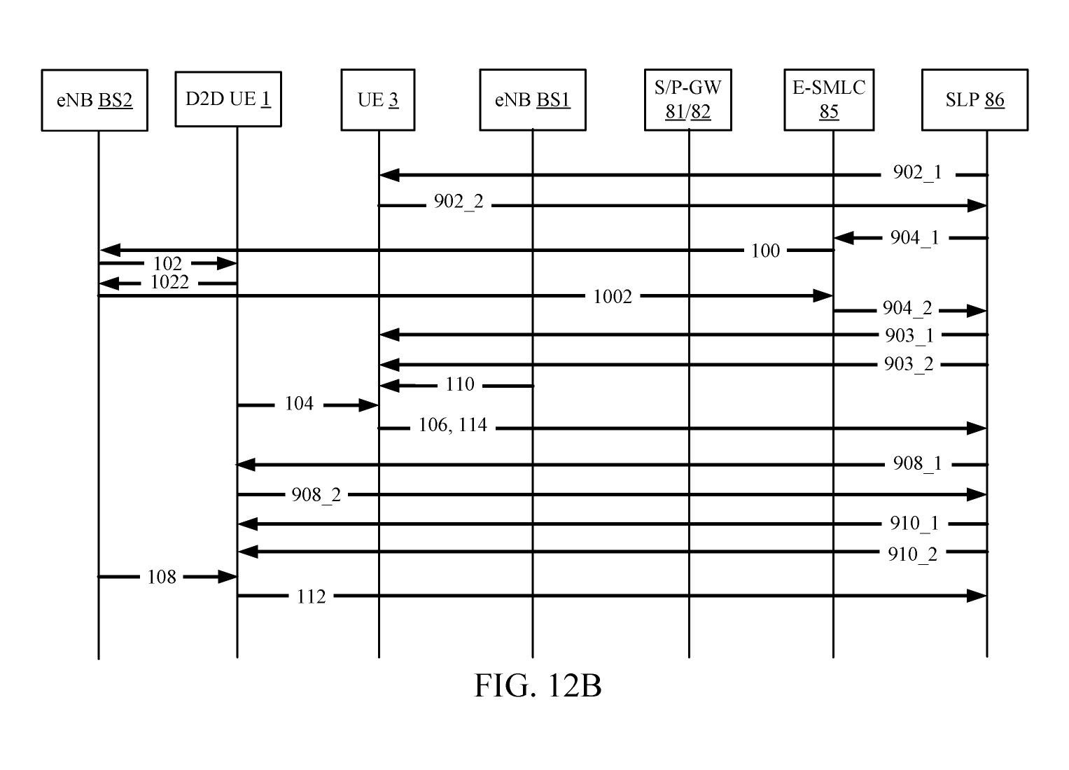

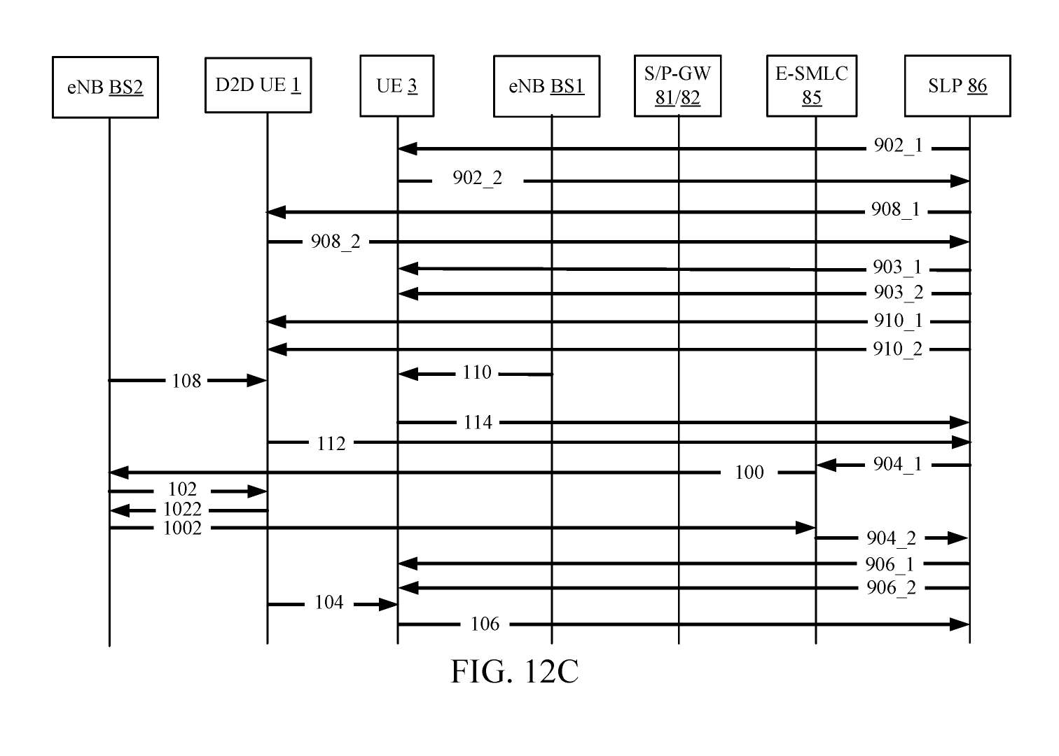

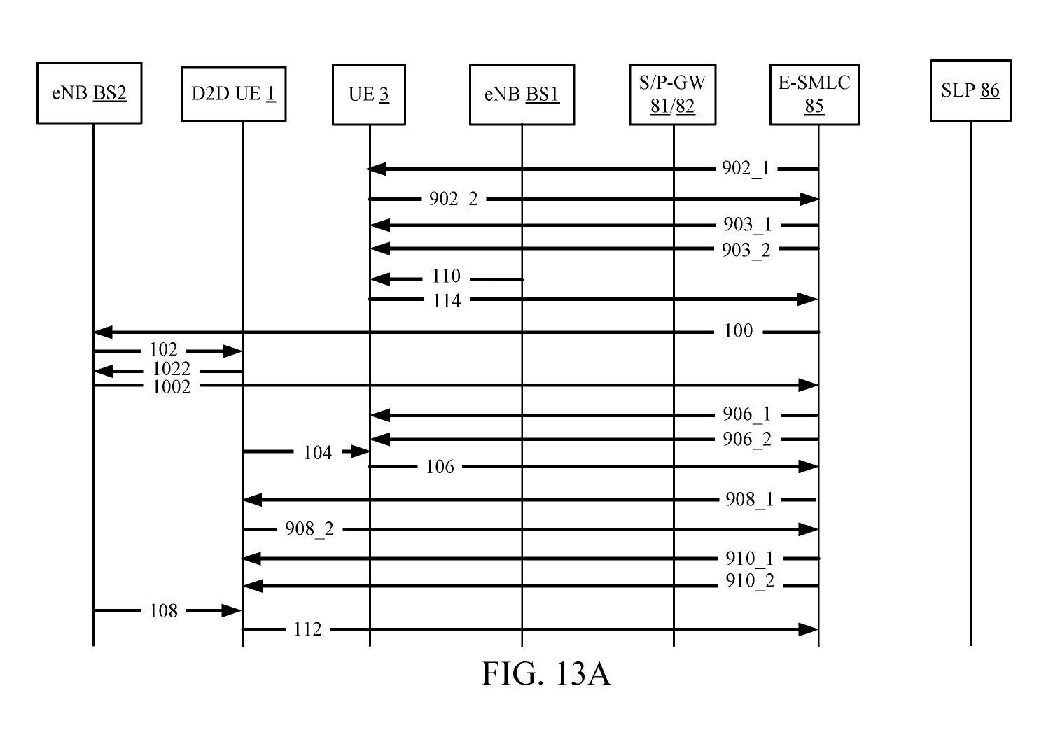

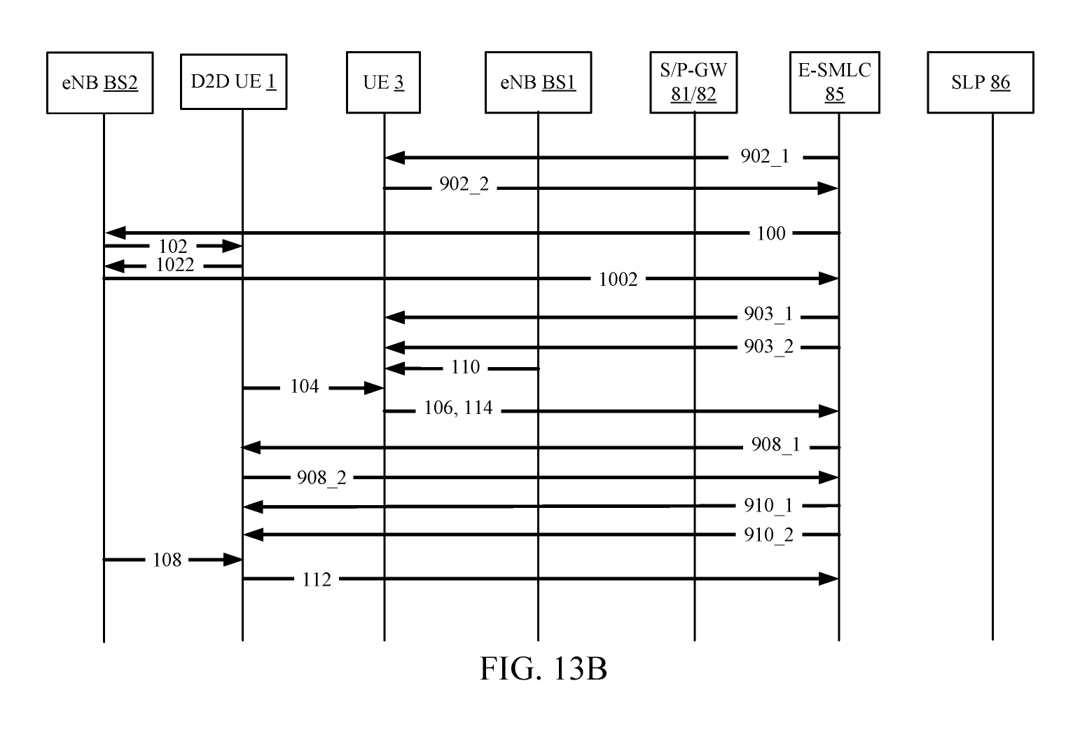

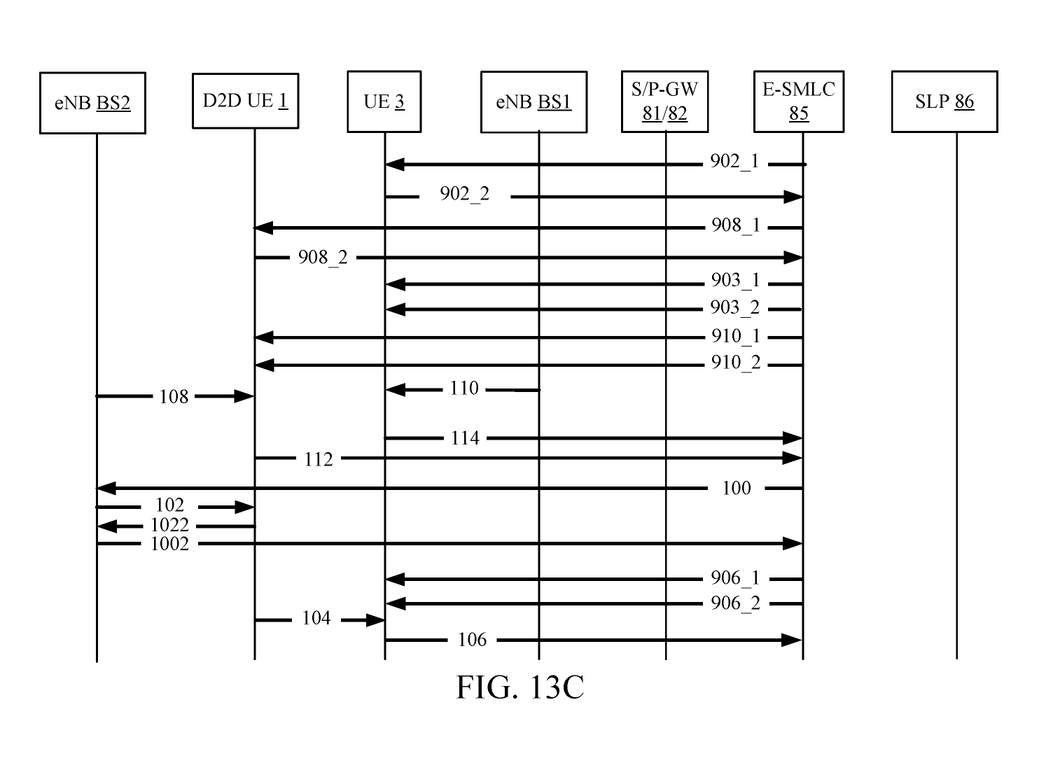

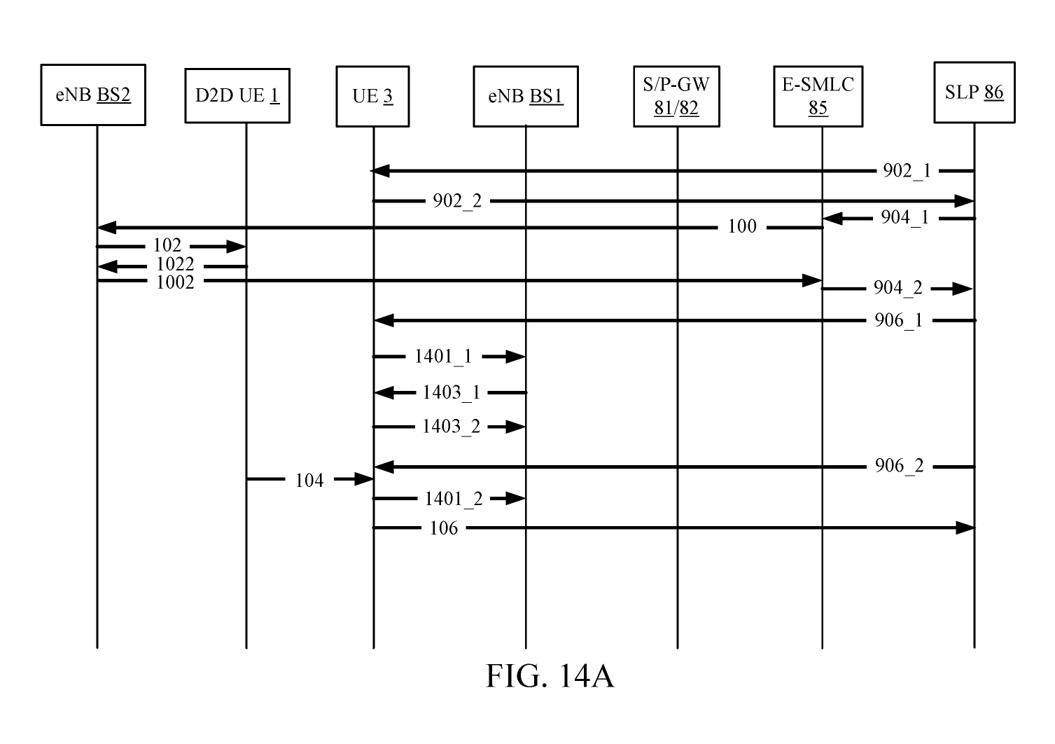

A ninth embodiment of the present invention is as shown in FIG. 11, which is a schematic view of a network architecture NA2 of the LTE mobile communication system, and the network architecture NA2 is adapted for use in the aforesaid second embodiment. Different from the network architecture NA1, the network architecture NA2 further comprises an eNB BS2. The eNB BS2 communicates with the MME 83, the E-SMLC 85 and the S-GW 81 respectively via the S1-C interface, the SLm interface and the S1_U interface (which is not depicted in FIG. 11 for simplification). FIG. 12A, FIG. 12B, FIG. 12C, FIG. 13A, FIG. 13B, FIG. 13C, FIG. 14A and FIG. 14B respectively depict signal transmission processes in different scenarios for positioning the UE 3. Similarly, most of the signal transmission of FIG. 12A, FIG. 12B, FIG. 12C, FIG. 13A, FIG. 13B FIG. 13C, FIG. 14A and FIG. 14B represents the signal transmission in a control plane rather than physical transmission paths of signals.

As compared to the scenario depicted in FIG. 9A, in the scenario depicted in FIG. 12A, the E-SMLC 85 transmits the OTDOA information request message 100 to the eNB BS2 instead of the eNB BS1. Thereafter, the eNB BS2 transmits the positioning reference signal transmission request message 102 to the D2D UE 1, and the D2D UE 1 transmits the positioning reference signal transmitting confirm message 1022 back to the eNB BS2. The eNB BS2 thus transmits the OTDOA information response message 1002 to the E-SMLC 85.

Similarly, the OTDOA information response message 1002 carries information associated with that the eNB BS2 requests the D2D UE 1 to transmit the D2D downlink reference signal 104 (e.g., but not limited to, the downlink resource region RG2, the ID of the D2D UE 1 or the like). Moreover, the eNB BS2 transmits the downlink reference signal 108 to be measured by the D2D UE 1.

As compared to the scenario depicted in FIG. 12A, in the scenario depicted in FIG. 12B, the UE 3 first measures the downlink reference signal 110 transmitted by the eNB BS1 and the D2D downlink reference signal 104 transmitted by the D2D UE 1, and then transmits the downlink measurement report message 106 and the downlink measurement report message 114 together to the SLP 86. Moreover, in this scenario, the SLP 86 only needs to transmit the LPP assistance data message 903_1 and the LPP request location information message 903_2 to the UE 3 and does not need to transmit the LPP assistance data message 906_1 and the LPP request location information message 906_2 to the UE 3.

As compared to the scenario depicted in FIG. 12A, in the scenario depicted in FIG. 12C, the D2D UE 1 first measures the downlink reference signal 108 transmitted by the eNB BS2 and then the UE 3 measures the D2D downlink reference signal 104 transmitted by the D2D UE 1. The overall operation can be readily appreciated by those of ordinary skill in the art based on FIG. 12A, FIG. 12B and FIG. 12C, and thus will not be further described herein.

As compared to the scenario depicted in FIG. 10A, in the scenario depicted in FIG. 13A, the E-SMLC 85 transmits the OTDOA information request message 100 to the eNB BS2 instead of the eNB BS1. Thereafter, the eNB BS2 transmits the positioning reference signal transmission request message 102 to the D2D UE 1, and the D2D UE 1 transmits the positioning reference signal transmitting confirm message 1022 back to the eNB BS2. The eNB BS2 thus transmits the OTDOA information response message 1002 to the E-SMLC 85. Moreover, the eNB BS2 transmits the downlink reference signal 108 to be measured by the D2D UE 1.

As compared to the scenario depicted in FIG. 13A, in the scenario depicted in FIG. 13B, the UE 3 first measures the downlink reference signal 110 transmitted by the eNB BS1 and the D2D downlink reference signal 104 transmitted by the D2D UE 1, and then transmits the downlink measurement report message 106 and the downlink measurement report message 114 together to the E-SMLC 85. Moreover, in this scenario, the E-SMLC 85 only needs to transmit the LPP assistance data message 903_1 and the LPP request location information message 903_2 to the UE 3 and does not need to transmit the LPP assistance data message 906_1 and the LPP request location information message 906_2 to the UE 3.

As compared to the scenario depicted in FIG. 13A, in the scenario depicted in FIG. 13C, the D2D UE 1 first measures the downlink reference signal 108 transmitted by the eNB BS2 and then the UE 3 measures the D2D downlink reference signal 104 transmitted by the D2D UE 1. The overall operation can be readily appreciated by those of ordinary skill in the art based on FIG. 13A, FIG. 13B and FIG. 13C, and thus will not be further described herein.

FIG. 14A and FIG. 14B depict the scenario where the frequency band configured for the eNB BS2 is different from the frequency band configured for the eNB BS1. In this case, the UE 3 needs to additionally perform an inter-frequency RSTD measurement procedure to measure the D2D downlink reference signal 104 transmitted by the D2D UE 1. For simplification, FIG. 14A and FIG. 14B only depict the associated signal transmission intended for the purpose of measuring by the UE 3 the D2D downlink reference signal 104 transmitted from the D2D UE 1.

As shown in FIG. 14A and FIG. 14B, in the inter-frequency RSTD measurement procedure, the UE 3 transmits an inter-frequency RSTD measurement indication message 1401_1 to the eNB BS1 so as to inform the eNB BS1 that it will temporarily switch to the inter-frequency to prevent the connection from being disconnected. Next, the eNB BS1 transmits a radio resource control (RRC) connection reconfiguration message 1403_1 to the UE 3. Then, the eNB BS1 transmits an RRC connection reconfiguration complete message 1403_2 to the UE 3.

After receiving the RRC connection reconfiguration complete message 1403_2, the UE 3 switches to the frequency band configured for the eNB BS2 so as to measure the D2D downlink reference signal 104 in the downlink resource region RG2 of the downlink resource on this frequency band. After measuring the D2D downlink reference signal 104, the UE 3 switches back to the frequency band configured for the eNB BS1 and transmits the inter-frequency RSTD measurement indication message 1401_2 to inform the eNB BS1 that the inter-frequency RSTD measurement has been completed.

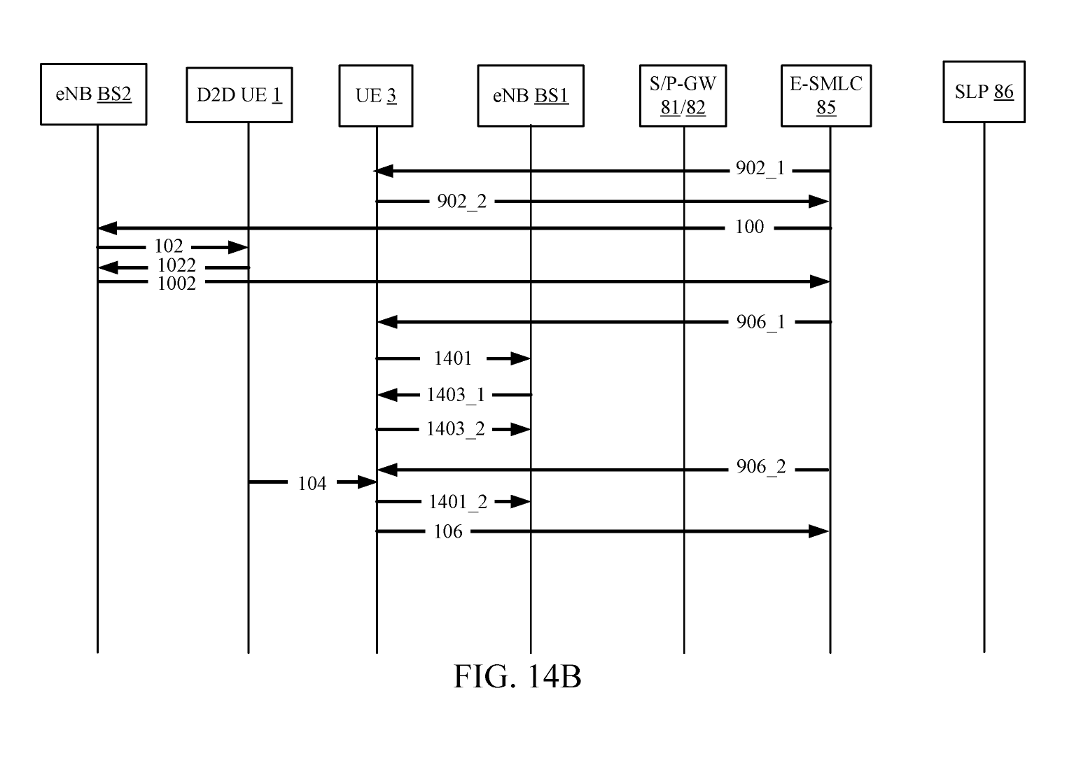

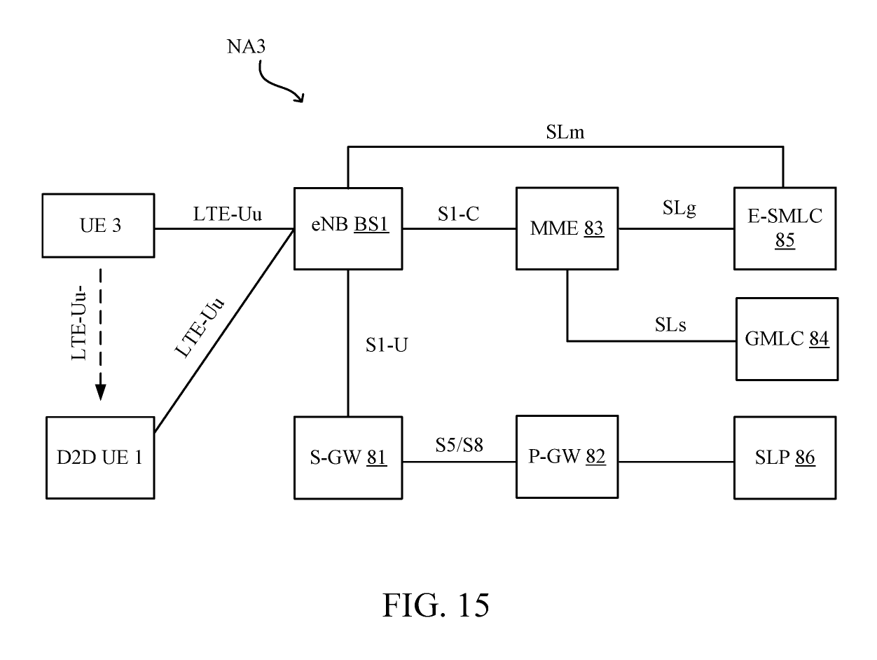

A tenth embodiment of the present invention is as shown in FIG. 15, which is a schematic view of a network architecture NA3 of the LTE mobile communication system. Different from the network architecture NA1, in the network architecture NA3, the UE 3 further transmits an uplink reference signal 1610 to the D2D UE 1 via an LTE-Uu-interface of the present invention. Further speaking, the LTE-Uu-interface is an uplink resource region allocated by the eNB BS1 or the backhaul device BD so that the UE 3 transmits the uplink reference signal 1610 in the uplink resource region. The uplink reference signal 1610 may be a sounding reference signal (SRS), a demodulation reference signal (DMRS) or a combination thereof.

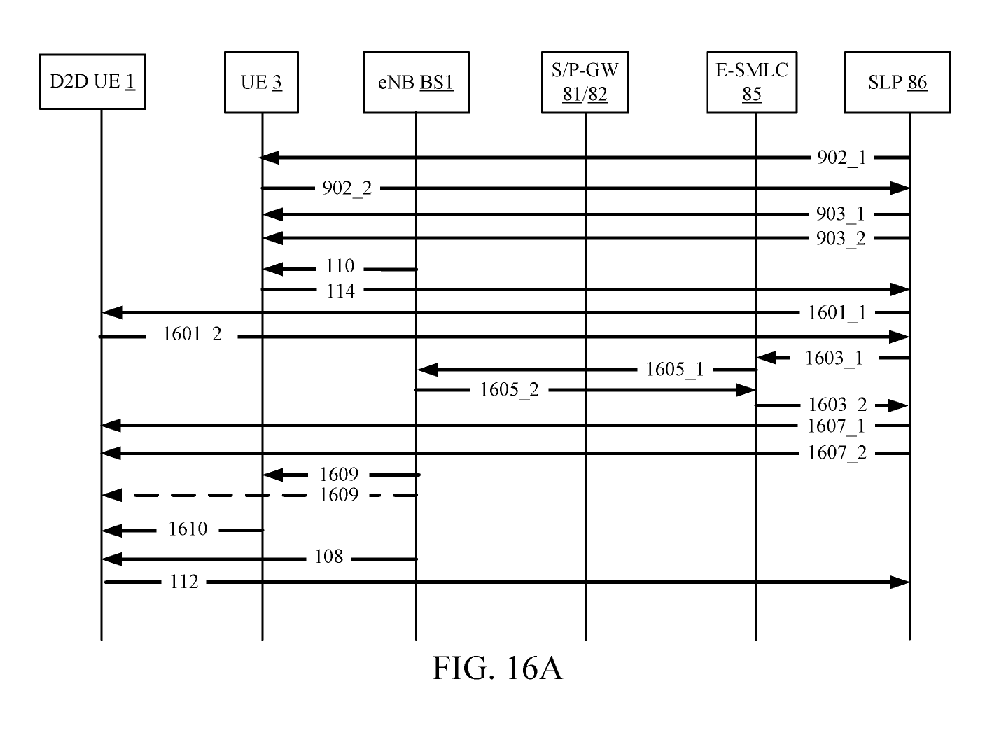

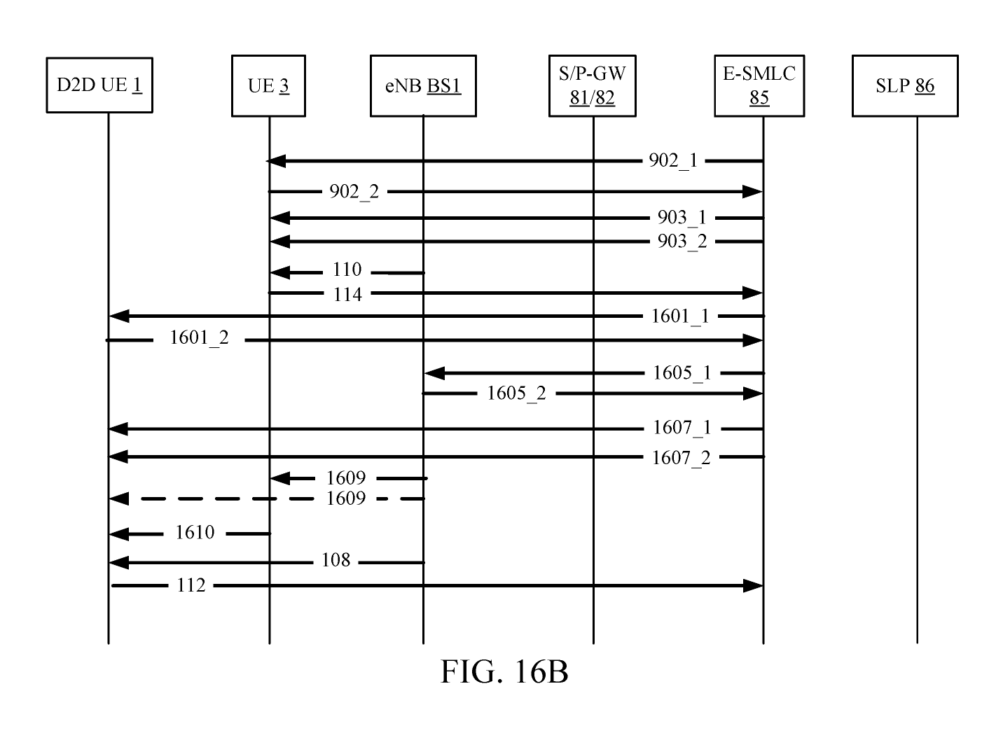

FIG. 16A and FIG. 16B respectively depict signal transmission processes in different scenarios for positioning the UE 3. Similarly, most of the signal transmission of FIG. 16A and FIG. 16B represents the signal transmission in a control plane rather than physical transmission paths of signals. In the scenario depicted in FIG. 16A, after the UE 3 measures the downlink reference signal 110 transmitted by the eNB BS1 and transmits the downlink measurement report message 114 to the SLP 86, the SLP 86 transmits an LPP request capabilities message 1601_1 to the D2D UE 1.

Thereafter, the D2D UE transmits an LPP provide capabilities message 1601_2 back to the SLP 86. Next, the SLP 86 transmits an uplink reference signal request message 1603_1 to the E-SMLC 85. The E-SMLC 85 transmits an uplink reference signal request message 1605_1 to the eNB BS1. The eNB BS1 transmits the uplink reference signal response message 1605_2 to the E-SMLC 85. The E-SMLC 85 transmits the uplink reference signal response message 1603_2 to the SLP 86.

Moreover, the uplink reference signal request message 1605_1 may have parameters of the SRS (e.g., but not limited to, a reference signal sequence index, allocated subframe and subcarrier information, periodical information, a frequency hopping index, timing advance between base stations or the like) and parameters of the DMRS (e.g., an allocated resource block) recorded therein. Moreover, in other embodiments, the uplink reference signal request message 1605_1 of the present invention may further comprise an information measurement timing reference.

Thereafter, the SLP 86 transmits an LPP assistance data message 1607_1 and an LPP request location information message 1607_2 to the D2D UE 1. Next, the eNB BS1 transmits a bandwidth allocation message 1609 to the UE 3 to allocate an uplink resource region so that the UE 3 uses the uplink resource region to transmit the uplink reference signal 1610. The bandwidth allocation message 1609 also carries associated parameters in the uplink reference signal request message 1605_1. Thereafter, the D2D UE 1 measures the uplink reference signal 1610 transmitted by the UE. Moreover, the D2D UE 1 also measures the downlink reference signal 108 transmitted by the eNB BS1. Thereafter, the D2D UE 1 transmits the D2D downlink measurement report message 112 to the SLP 86. In this way, the SLP 86 can determine the location information of the UE 3 at least based on the D2D downlink measurement report message 112 and the downlink measurement report message 114.

It shall be appreciated that, it is assumed in this embodiment that the D2D UE 1 can also receive the bandwidth allocation message 1609, so the D2D UE 1 can obtain the uplink resource region used by the UE 3 to transmit the uplink reference signal 1610 from the bandwidth allocation message 1609 and then measure the uplink reference signal 1610. However, in other embodiments, the D2D UE 1 may also be informed of the uplink resource region allocated for the UE 3 to transmit the uplink reference signal 1610 via other messages.

As compared to the scenario depicted in FIG. 16A, in the scenario depicted in FIG. 16B, the LPP request capabilities message 902_1 is generated by the E-SMLC 85 and then transmitted to the UE 3, and the LPP provide capabilities message 902_2 is transmitted back to the E-SMLC 85 from the UE 3. The LPP assistance data message 903_1 and the LPP request location information message 903_2 are also generated by the E-SMLC 85 and then transmitted to the UE 3. The LPP assistance data message 1607_1 and the LPP request location information message 1607_2 are also generated by the E-SMLC 85 and then transmitted to the D2D UE 1.

The D2D downlink measurement report message 112 and the downlink measurement report message 114 are transmitted back to the E-SMLC 85 so as to be used by the E-SMLC 85 for determining the location information of the UE 3. The SLP 86 does not need to transmit the uplink reference signal request message 1603_1 to the E-SMLC 85 or receive the uplink reference signal response message 1603_2 from the E-SMLC 85. In other words, different from the scenario depicted in FIG. 16A, the positioning service in the scenario depicted in FIG. 16B is achieved by the E-SMLC 85 rather than the SLP 86.

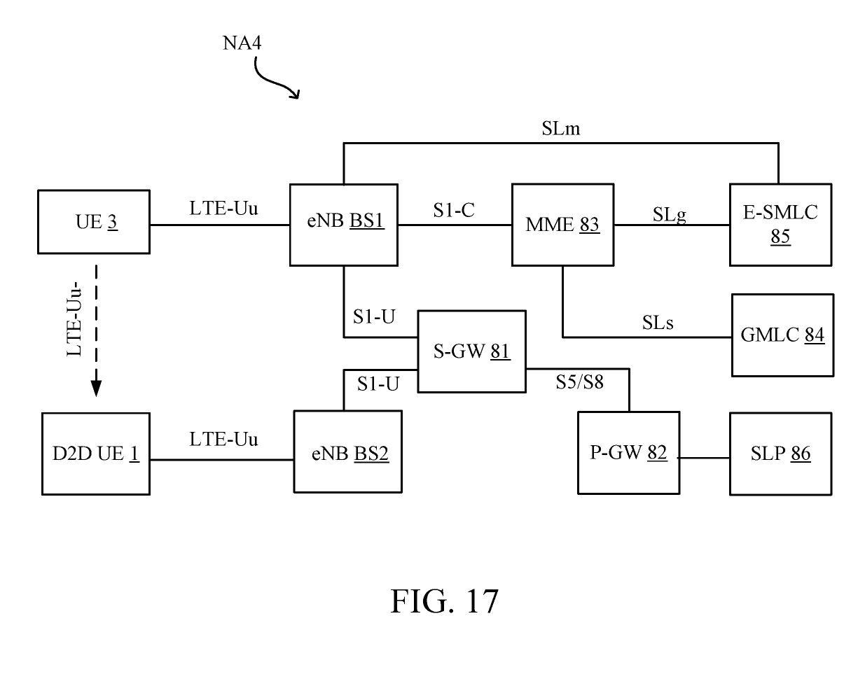

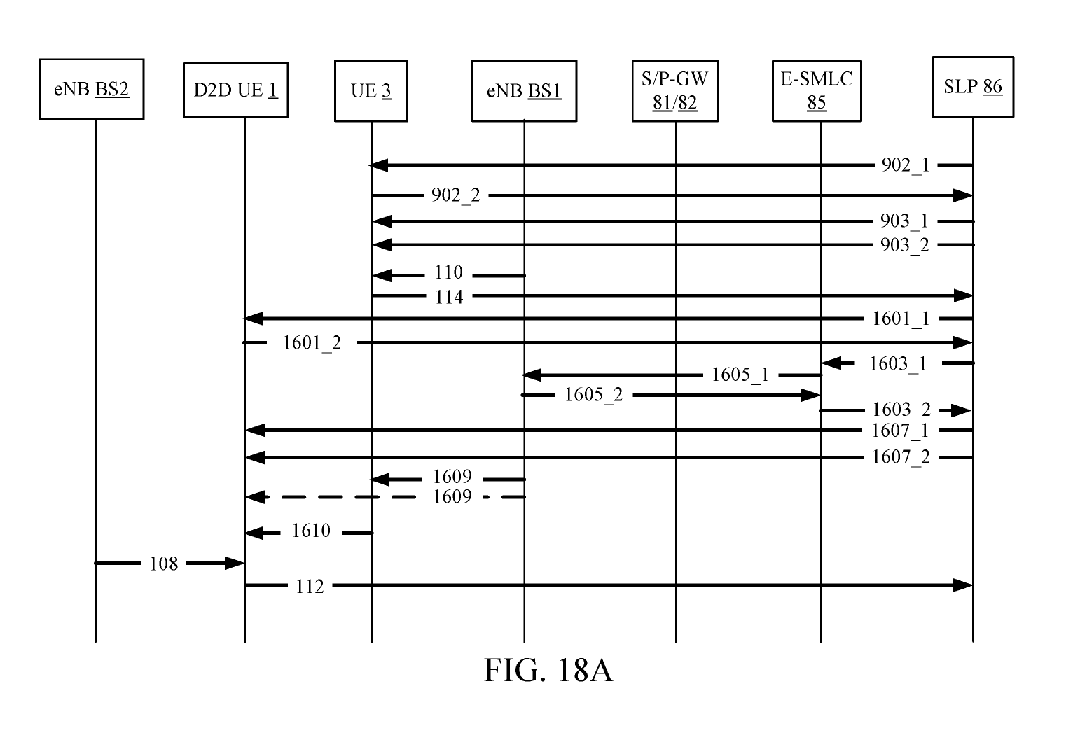

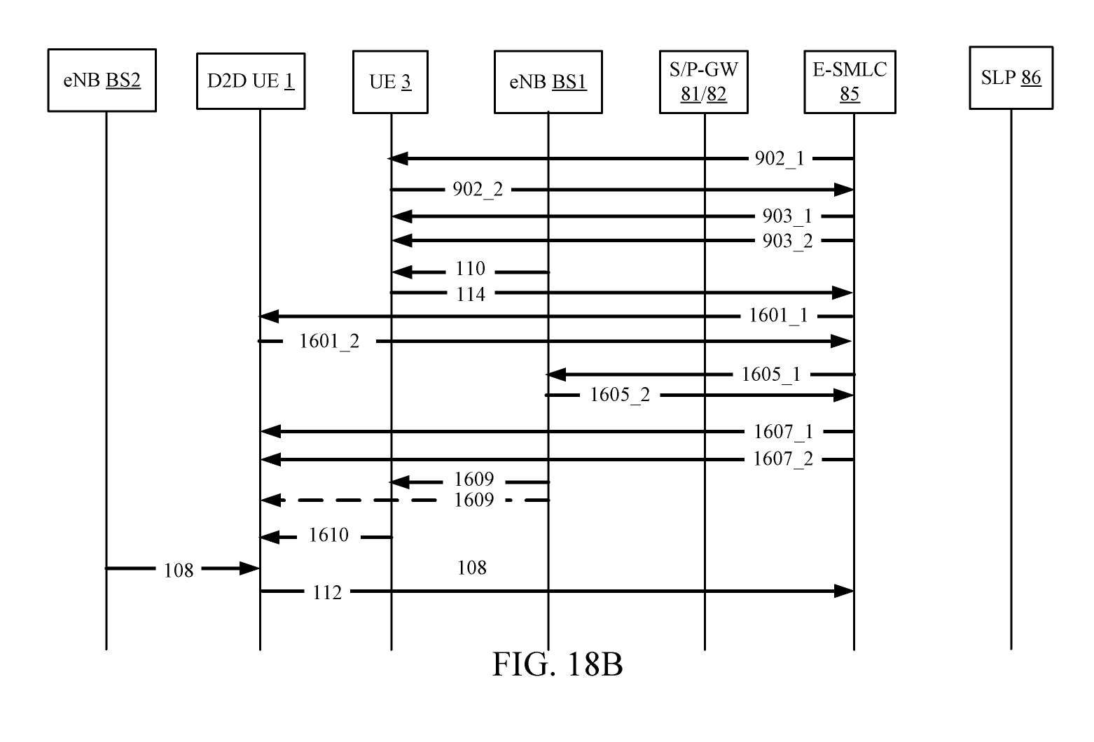

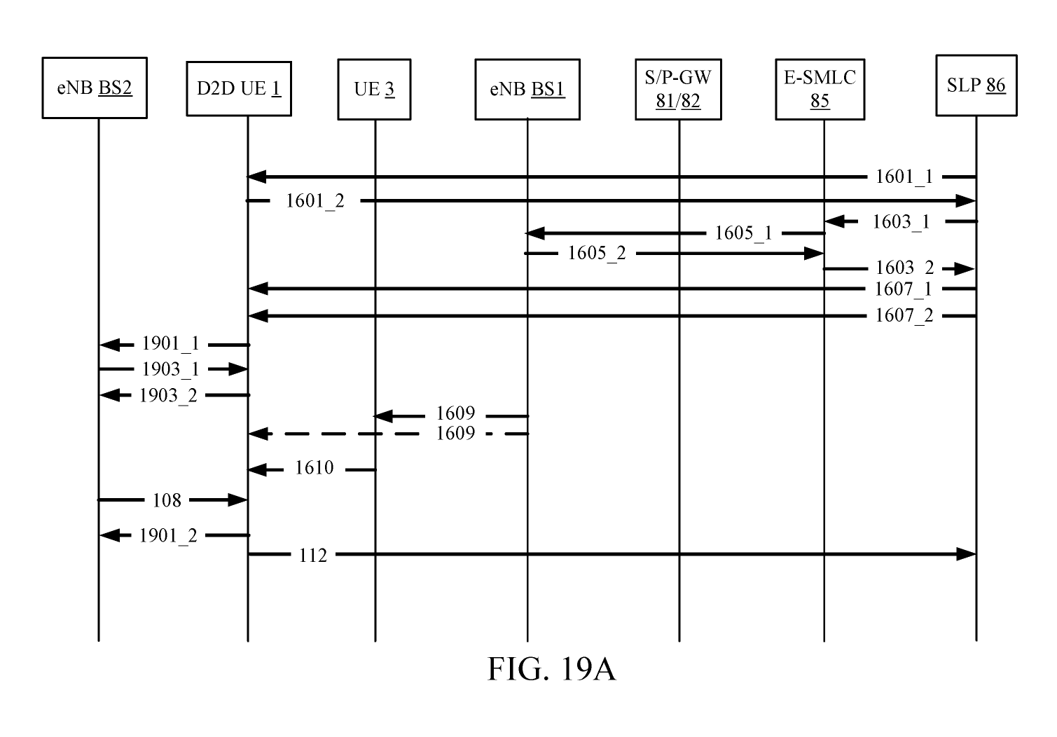

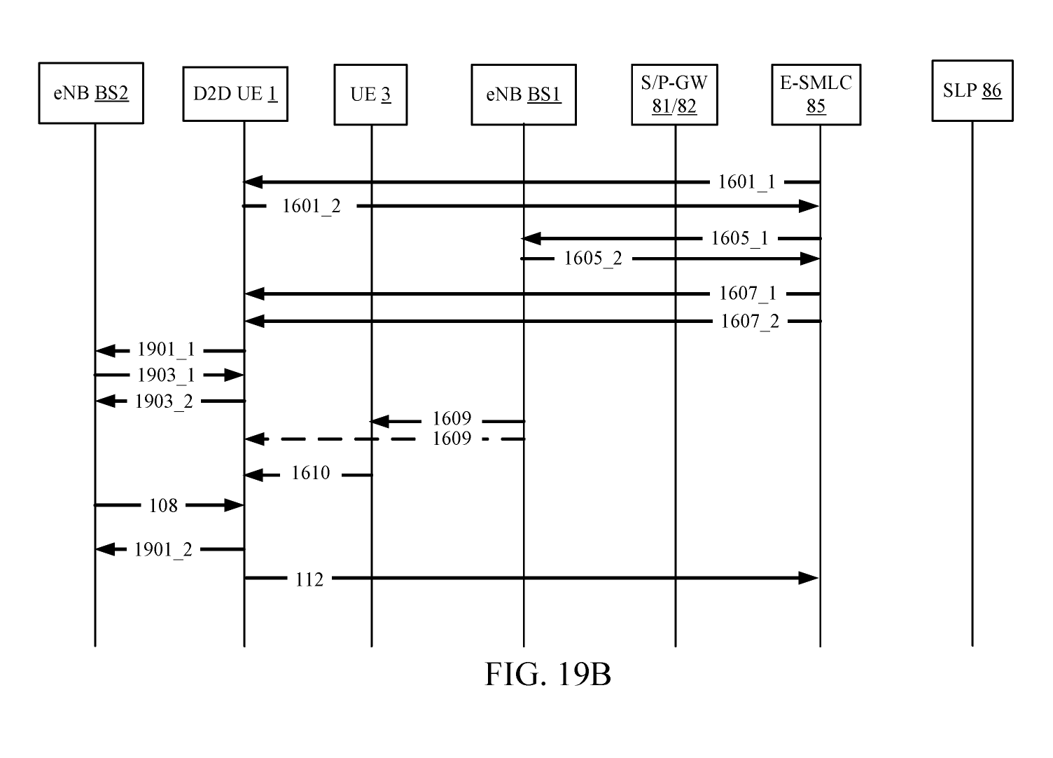

An eleventh embodiment of the present invention is as shown in FIG. 17, which is a schematic view of a network architecture NA4 of the LTE mobile communication system. Different from the network architecture NA2, in the network architecture NA4, the UE 3 further transmits the uplink reference signal 1610 to the D2D UE 1 via the LTE-Uu-interface of the present invention. FIG. 18A, FIG. 18B, FIG. 19A and FIG. 19B respectively depict signal transmission processes in different scenarios for positioning the UE 3. Similarly, most of the signal transmission of FIG. 18A, FIG. 18B, FIG. 19A and FIG. 19B represents the signal transmission in a control plane rather than physical transmission paths of signals.

As compared to the scenario depicted in FIG. 16A, in the scenario depicted in FIG. 18A, the downlink reference signal 108 is transmitted by the eNB BS2 to be measured by the D2D UE 1. As compared to the scenario depicted in FIG. 16B, in the scenario depicted in FIG. 18B, the downlink reference signal 108 is transmitted by the eNB BS2 to be measured by the D2D UE 1.

FIG. 19A and FIG. 19B depicts the scenario where the frequency band configured for the eNB BS2 is different from the frequency band configured for the eNB BS1. In this case, the D2D UE 1 needs to additionally perform an inter-frequency RSTD measurement procedure to measure the uplink reference signal 1610 transmitted by the UE 3. For simplification, FIG. 19A and FIG. 19B only depict the associated signal transmission intended for the purpose of measuring by the D2D UE 1 the uplink reference signal 1610 transmitted from the UE 3.

As shown in FIG. 19A and FIG. 19B, in the inter-frequency RSTD measurement procedure, the D2D UE 1 transmits an inter-frequency RSTD measurement indication message 1901_1 to the eNB BS2 so as to inform the eNB BS2 that it will temporarily switch to the inter-frequency to prevent the connection from being disconnected. Next, the eNB BS2 transmits an RRC connection reconfiguration message 1903_1 to the D2D UE 1. Then, the eNB BS2 transmits an RRC connection reconfiguration complete message 1903_2 to the D2D UE 1.

After receiving the RRC connection reconfiguration complete message 1903_2, the D2D UE 1 switches to the frequency band configured for the eNB BS1 so as to measure the uplink reference signal 1610 in the uplink resource region of the uplink resource on this frequency band. After measuring the uplink reference signal 1610, the D2D UE 1 switches back to the frequency band configured for the eNB BS2 and transmits the inter-frequency RSTD measurement indication message 1901_2 to inform the eNB BS2 that the inter-frequency RSTD measurement has been completed.

According to the above descriptions, in an assistant positioning mechanism of the present invention, the D2D UE can transmit a downlink reference signal in the downlink resource so that the UE to be positioned measures the downlink reference signal and transmits the measurement result to the backhaul device of the mobile communication system to assist the backhaul device in positioning. Moreover, in another assistant positioning mechanism of the present invention, the UE to be positioned can transmit an uplink reference signal in the uplink resource so that the D2D UE measures the uplink reference signal and transmits the measurement result to the backhaul device of the mobile communication system to assist the backhaul device in positioning.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A device to device (D2D) user equipment (UE) for a mobile communication system, the mobile communication system comprising the D2D UE, a UE, a base station and a backhaul device, the mobile communication system defining an uplink resource and a downlink resource, the D2D UE having a D2D signal transmission capability of using the uplink resource, the D2D UE being near to the UE, the base station connecting to the backhaul device, the D2D UE connecting to the base station and comprising:
a transceiver; and
a processor electrically connected to the transceiver, being configured to receive a positioning reference signal transmission request message from the base station via the transceiver, generate a D2D downlink reference signal according to the positioning reference signal transmission request message, and transmit the D2D downlink reference signal in a downlink resource region of the downlink resource via the transceiver;
wherein the positioning reference signal transmission request message indicates the downlink resource region of the downlink resource, the D2D downlink reference signal is measured by the UE, and the UE generates a downlink measurement report message after measuring the D2D downlink reference signal and transmits the downlink measurement report message to the backhaul device so that the backhaul device determines location information of the UE based on the downlink measurement report message.

2. The D2D UE of claim 1, wherein the base station further transmits a downlink reference signal, and the processor further measures the downlink reference signal via the transceiver to generate a D2D downlink measurement report message and transmits the D2D downlink measurement report message to the backhaul device via the transceiver so that the backhaul device determines the location information of the UE based on the downlink measurement report message and the D2D downlink measurement report message.

3. The D2D UE of claim 1, wherein the mobile communication system further comprises another base station, and the UE connects to the another base station.

4. The D2D UE of claim 3, wherein the base station further transmits a downlink reference signal, the processor further measures the downlink reference signal via the transceiver to generate a D2D downlink measurement report message and transmits the D2D downlink measurement report message to the backhaul device via the transceiver, the another base station further transmits another downlink reference signal, the UE further measures the another downlink reference signal to generate another downlink measurement report message and transmits the another downlink measurement report message to the backhaul device, and the backhaul device determines the location information of the UE based on the downlink measurement report message, the another downlink measurement report message and the D2D downlink measurement report message.

5. The D2D UE of claim 3, wherein the base station is configured with the uplink resource and the downlink resource of a frequency band, the another base station is configured with the uplink resource and the downlink resource of another frequency band different from the frequency band, the processor processes the D2D downlink reference signal to be carried in the downlink resource region of the downlink resource on the frequency band via the transceiver, and the UE measures the D2D downlink reference signal of the downlink resource carried in the downlink resource on the frequency band.

6. The D2D UE of claim 1, wherein the mobile communication system employs an Orthogonal Frequency-Division Multiple Access (OFDMA) technology, and the downlink resource region is a subframe.

7. An assistant positioning method for a device to device (D2D) user equipment (UE) of a mobile communication system, the mobile communication system comprising the D2D UE, a UE, a base station and a backhaul device, the mobile communication system defining an uplink resource and a downlink resource, the D2D UE having a D2D signal transmission capability of using the uplink resource, the D2D UE being near to the UE, the base station connecting to the backhaul device, and the D2D UE connecting to the base station and comprising a transceiver and a processor, the assistant positioning method being executed by the processor, the method comprising:
(a) receiving a positioning reference signal transmission request message from the base station via the transceiver, wherein the positioning reference signal transmission request message indicates a downlink resource region of the downlink resource;
(b) generating a D2D downlink reference signal according to the positioning reference signal transmission request message; and
(c) transmitting the D2D downlink reference signal in the downlink resource region via the transceiver;
wherein the D2D downlink reference signal is measured by the UE, and the UE generates a downlink measurement report message after measuring the D2D downlink reference signal and transmits the downlink measurement report message to the backhaul device so that the backhaul device determines location information of the UE based on the downlink measurement report message.

8. The assistant positioning method of claim 7, wherein the base station further transmits a downlink reference signal, and the assistant positioning method further comprises:
measuring the downlink reference signal via the transceiver to generate a D2D downlink measurement report message; and
transmitting the D2D downlink measurement report message to the backhaul device via the transceiver so that the backhaul device determines the location information of the UE based on the downlink measurement report message and the D2D downlink measurement report message.

9. The assistant positioning method of claim 7, wherein the mobile communication system further comprises another base station, and the UE connects to the another base station.

10. The assistant positioning method of claim 9, wherein the base station further transmits a downlink reference signal, and the assistant positioning method further comprises:
measuring the downlink reference signal via the transceiver to generate a D2D downlink measurement report message; and
transmitting the D2D downlink measurement report message to the backhaul device via the transceiver;
wherein the another base station further transmits another downlink reference signal, the UE further measures the another downlink reference signal to generate another downlink measurement report message and transmits the another downlink measurement report message to the backhaul device, and the backhaul device determines the location information of the UE based on the downlink measurement report message, the another downlink measurement report message and the D2D downlink measurement report message.

11. The assistant positioning method of claim 9, wherein the base station is configured with the uplink resource and the downlink resource of a frequency band, the another base station is configured with the uplink resource and the downlink resource of another frequency band different from the frequency band, and the step (c) further comprises:
processing the D2D downlink reference signal to be carried in the downlink resource region of the downlink resource on the frequency band via the transceiver;
wherein the UE measures the D2D downlink reference signal carried in the downlink resource on the frequency band.

12. The assistant positioning method of claim 7, wherein the mobile communication system employs an Orthogonal Frequency-Division Multiple Access (OFDMA) technology, and the downlink resource region is a subframe.

13. A user equipment (UE) for a mobile communication system, the mobile communication system comprising the UE, a D2D UE, a base station, another base station and a backhaul device, the mobile communication system defines an uplink resource and a downlink resource, the D2D UE having a D2D signal transmission capability of using the uplink resource, the UE being near to the D2D UE, the base station connecting to the backhaul device, and the UE connecting to the base station and comprising:
a transceiver; and
a processor electrically connected to the transceiver, being configured to measure via the transceiver a D2D downlink reference signal transmitted by the D2D UE so as to generate a downlink measurement report message, and transmit the downlink measurement report message to the backhaul device via the transceiver so that the backhaul device determines location information of the UE based on the downlink measurement report message;
wherein when the D2D UE connects to the base station, the D2D UE receives a positioning reference signal transmission request message from the base station, and when the D2D UE connects to the another base station, the D2D UE receives the positioning reference signal transmission request message from the another base station;
wherein the positioning reference signal transmission request message indicates the downlink resource region of the downlink resource, and the D2D UE generates the D2D downlink reference signal according to the positioning reference signal transmission request message and transmits the D2D downlink reference signal in the downlink resource region.

14. The UE of claim 13, wherein the base station further transmits a downlink reference signal, and the processor further measures the downlink reference signal via the transceiver to generate another downlink measurement report message and transmits the another downlink measurement report message to the backhaul device via the transceiver so that the backhaul device determines the location information of the UE based on the downlink measurement report message and the another downlink measurement report message.

15. The UE of claim 14, wherein when the D2D UE connects to the base station, the base station further transmits another downlink reference signal, and the D2D UE further measures the another downlink reference signal to generate a D2D downlink measurement report message and transmits the D2D downlink measurement report message to the backhaul device so that the backhaul device determines the location information of the UE based on the downlink measurement report message, the another downlink measurement report message and the D2D downlink measurement report message.

16. The UE of claim 14, wherein when the D2D UE connects to the another base station, the another base station further transmits another downlink reference signal, the D2D UE further measures the another downlink reference signal to generate a D2D downlink measurement report message and transmits the D2D downlink measurement report message to the backhaul device, and the backhaul device determines the location information of the UE based on the downlink measurement report message, the another downlink measurement report message and the D2D downlink measurement report message.

17. The UE of claim 16, wherein the base station is configured with the uplink resource and the downlink resource of a frequency band, the another base station is configured with the uplink resource and the downlink resource of another frequency band different from the frequency band, and the processor measures the D2D downlink reference signal carried in the downlink resource of the another frequency band via the transceiver.

18. The UE of claim 13, wherein the mobile communication system employs an Orthogonal Frequency-Division Multiple Access (OFDMA) technology, and the downlink resource region is a subframe.

19. A base station for a mobile communication system, the mobile communication system comprising a UE, a D2D UE, the base station and a backhaul device and defining an uplink resource and a downlink resource, the D2D UE having a D2D signal transmission capability of using the uplink resource, the D2D UE being near to the UE, the base station connecting to the backhaul device, the D2D UE connecting to the base station, the base station comprising:
a network interface connecting to the backhaul network;
a transceiver;
a processor electrically connected to the network interface and the transceiver, being configured to receive an Observed Time Difference of Arrival (OTDOA) information request message from the backhaul device via the network interface so as to generate a positioning reference signal transmission request message according to the OTDOA information request message, and transmit the positioning reference signal transmission request message to the D2D UE via the transceiver;
wherein the positioning reference signal transmission request message indicates a downlink resource region of the downlink resource so that the D2D UE generates a D2D downlink reference signal according to the positioning reference signal transmission request message and transmits the D2D downlink reference signal in the downlink resource region, and after measuring the D2D downlink reference signal, the UE generates a downlink measurement report message and transmits the downlink measurement report message to the backhaul device so that the backhaul device determines location information of the UE based on the downlink measurement report message.

20. A backhaul device for a mobile communication system, the mobile communication system comprising a UE, a D2D UE, a base station, another base station and the backhaul device and defining an uplink resource and a downlink resource, the D2D UE having a D2D signal transmission capability of using the uplink resource, the D2D UE being near to the UE, the base station connecting to the backhaul device, the D2D UE connecting to the base station, the backhaul device comprising:
a network unit connecting to the base station; and
a processing unit, being configured to generate an Observed Time Difference of Arrival (OTDOA) information request message and transmit the OTDOA information request message to the base station via the network unit so that the base station generates a positioning reference signal transmission request message according to the OTDOA information request message and transmits the positioning reference signal transmission request message to the D2D UE;
wherein the positioning reference signal transmission request message indicates a downlink resource region of the downlink resource so that the D2D UE generates a D2D downlink reference signal according to the positioning reference signal transmission request message and transmits the D2D downlink reference signal in the downlink resource region, and after measuring the D2D downlink reference signal, the UE generates a downlink measurement report message and transmits the downlink measurement report message to the backhaul device;
wherein the processing unit further receives the downlink measurement report message via the network unit and determines location information of the UE based on the downlink measurement report message.
